(19) United States
(12) Patent Application Publication
(10) Pub. No.: US 2022/0077997 A1
(43) Pub. Date: Mar. 10, 2022

(54) TBS DETERMINATION WITH QUANTIZATION OF INTERMEDIATE NUMBER OF INFORMATION BITS

(71) Applicant: TELEFONAKTIEBOLAGET LM ERICSSON (PUBL), STOCKHOLM (SE)

(72) Inventors: Yufei Blankenship, KILDEER, IL (US); Mattias Andersson, SUNDBYBERG (SE); Sara Sandberg, LULEÅ (SE)

(21) Appl. No.: 17/423,393

(22) PCT Filed: Jan. 15, 2020
(86) PCT No.: PCT/IB2020/050318

§ 371 Date: Jul. 15, 2021

Related U.S. Application Data
(60) Provisional application No. 62/792,756, filed on Jan. 15, 2019.

(51) Int. Cl. H04L 5/00; H04L 1/00

(52) U.S. Cl. CPC H04L 5/0094; H04L 1/0007

(57) ABSTRACT

A method by a transmitter or receiver includes determining an intermediate number of information bits (Ninfo) to be transmitted from a number of allocated physical resource blocks (PRB) a number of resource elements (REs) per PRB, a number of multiple input multiple output (MIMO) layers, a modulation order and a target code rate for transmission of the information bits; quantizing the intermediate number of information bits as a first integer multiple of a second integer, wherein the second integer is equal to 2-to-the-power of a third integer, to provide a quantized intermediate number of information bits; determining a transport block size from the quantized intermediate number of information bits; and transmitting or receiving a transport block over a physical channel according to the determined transport block size.

### RELATED APPLICATION

The present application claims the benefit of and priority to U.S. Provisional Patent Application No. 62/792,756, filed Jan. 15, 2019, entitled “TBS DETERMINATION WITH QUANTIZATION OF INTERMEDIATE NUMBER OF INFORMATION BITS,” the disclosure of which is hereby incorporated herein by reference in its entirety.

### TECHNICAL FIELD

The present disclosure relates to Transport Block Size (TBS) determination in a cellular communications network.

### BACKGROUND

In the Third Generation Partnership Project (3GPP), there is an ongoing Study Item that looks into a new radio interface for Fifth Generation (5G) networks. Terms for denoting this new and next generation technology have not yet converged, so the terms New Radio (NR) and 5G are used interchangeably. Moreover, a base-station can be referred to as NR base station (gNB) instead of an enhanced or evolved Node B (eNB). Alternatively, the term Transmission-Receive-Point (TRP) can also be used.

Slot Structure

A NR slot consists of several Orthogonal Frequency Division Multiplexing (OFDM) symbols. According to current agreements, a NR slot consists of either 7 or 14 symbols for OFDM subcarrier spacing ≤60 kilohertz (kHz) and 14 symbols for OFDM subcarrier spacing >60 kHz. FIG. 1 shows a subframe with 14 OFDM symbols. In FIG. 1, Tₛ and T_{symb} denote the slot and OFDM symbol duration, respectively. In addition, a slot may also be shortened to accommodate downlink (DL)/uplink (UL) transient period or both DL and UL transmissions. Potential variations are shown in FIG. 2.

Furthermore, NR also defines mini-slots. Mini-slots are shorter than slots and can start at any symbol. According to current agreements, a mini-slot duration can be from 1 or 2 symbols up to the number of symbols in a slot minus 1. Mini-slots are used if the transmission duration of a slot is too long or the occurrence of the next slot start (slot alignment) is too late. Applications of mini-slots include, among others, latency critical transmissions and unlicensed spectrum where a transmission should start immediately after Listen-Before-Talk (LBT) succeeds. For latency critical transmissions, both mini-slot length and frequent opportunity of mini-slot are important. For unlicensed spectrum, the frequent opportunity of mini-slot is especially important. An example of mini-slots is shown in FIG. 3.

Control Information

Physical Downlink Control Channels (PDCCHs) are used in NR for Downlink Control Information (DCI), e.g. downlink scheduling assignments and uplink scheduling grants. The PDCCHs are in general transmitted at the beginning of a slot and relate to data in the same or a later slot. For mini-slots, PDCCH can be transmitted within a regular slot. Different formats (sizes) of the PDCCHs are possible to handle different DCI payload sizes and different aggregation levels, i.e., different code rate for a given payload size. A User Equipment device (UE) is configured, implicitly and/or explicitly, to monitor (i.e., search) for PDCCH candidates of different aggregation levels and DCI payload sizes. Upon detecting a valid DCI message by successful decoding of a candidate where the DCI contains an Identity (ID) that the UE is told to monitor, the UE follows the DCI. For example, the UE receives the corresponding downlink data or transmits in the uplink in accordance with the DCI.

In NR, there are currently discussions on whether to introduce a “broadcasted control channel” to be received by multiple UEs. The channel has been referred to as “group common PDCCH.” The exact content of such a channel is currently under discussion. One example of information that might be put in such a channel is information about the slot format, i.e. whether a certain slot is uplink or downlink, which portion of a slot is UL or DL; information which can be useful in a dynamic Time Division Duplexing (TDD) system.

Transmission Parameter Determination

The DCI carries several parameters to instruct the UE on how to receive a downlink transmission or to transmit in the uplink. For example, the Frequency Division Duplexing (FDD) Long Term Evolution (LTE) DCI format 1A carries parameter such as localized/distributed Virtual Resource Block (VRB) assignment flag, resource block assignment, Modulation and Coding Scheme (MCS), Hybrid Automatic Repeat Request (HARQ) process number, new data indicator, redundancy version, and Transmit Power Control (TPC) command for Physical Uplink Control Channel (PUCCH).

One of the key parameters for the UE to receive or transmit in the system is the size of the data block, which is referred to as the Transport Block Size (TBS), to be channel coded and modulated. In LTE, the TBS is determined as follows. The UE uses the MCS given by the DCI to read a TBS index I_{TBS} from an MCS table. An example of the MCS table is shown in Table 1. The UE determines the number of Physical Resource Blocks (PRBs) as N_{PRB} from the resource block assignment given in the DCI.

The UE uses the TBS index I_{TBS} and the number of PRBs N_{PRB} to read the actual TBS from a TBS table. A portion of the TBS table is shown in Table 2 as an example.

TABLE 1
LTE modulation and coding scheme (MCS) table

| MCS Index | Modulation Order | TBS Index |
|---|---|---|
| I_{MCS} | Qₘ | I_{TBS} |
| 0 | 2 | 0 |
| 1 | 2 | 1 |
| 2 | 2 | 2 |
| 3 | 2 | 3 |
| 4 | 2 | 4 |
| 5 | 2 | 5 |
| 6 | 2 | 6 |
| 7 | 2 | 7 |
| 8 | 2 | 8 |
| 9 | 2 | 9 |
| 10 | 4 | 9 |
| 11 | 4 | 10 |
| 12 | 4 | 11 |
| 13 | 4 | 12 |
| 14 | 4 | 13 |
| 15 | 4 | 14 |
| 16 | 4 | 15 |
| 17 | 6 | 15 |
| 18 | 6 | 16 |
| 19 | 6 | 17 |
| 20 | 6 | 18 |
| 21 | 6 | 19 |
| 22 | 6 | 20 |
| 23 | 6 | 21 |
| 24 | 6 | 22 |
| 25 | 6 | 23 |
| 26 | 6 | 24 |
| 27 | 6 | 25 |
| 28 | 6 | 26 |
| 29 | 2 | reserved |
| 30 | 4 | |
| 31 | 6 | |

TABLE 2
LTE transport block size (TBS) table
(dimension is 27 × 110)

| | N | | | | | | | | | |
|---|---|---|---|---|---|---|---|---|---|---|
| I_{TBS} | 1 | 2 | 3 | 4 | 5 | 6 | 7 | 8 | 9 | . . . |
| 0 | 16 | 32 | 56 | 88 | 120 | 152 | 176 | 208 | 224 | . . . |
| 1 | 24 | 56 | 88 | 144 | 176 | 208 | 224 | 256 | 328 | . . . |
| 2 | 32 | 72 | 144 | 176 | 208 | 256 | 296 | 328 | 376 | . . . |
| 3 | 40 | 104 | 176 | 208 | 256 | 328 | 392 | 440 | 504 | . . . |
| 4 | 56 | 120 | 208 | 256 | 328 | 408 | 488 | 552 | 632 | . . . |
| 5 | 72 | 144 | 224 | 328 | 424 | 504 | 600 | 680 | 776 | . . . |
| 6 | 328 | 176 | 256 | 392 | 504 | 600 | 712 | 808 | 936 | . . . |
| 7 | 104 | 224 | 328 | 472 | 584 | 712 | 840 | 968 | 1096 | . . . |
| 8 | 120 | 256 | 392 | 536 | 680 | 808 | 968 | 1096 | 1256 | . . . |
| 9 | 136 | 296 | 456 | 616 | 776 | 936 | 1096 | 1256 | 1416 | . . . |
| 10 | 144 | 328 | 504 | 680 | 872 | 1032 | 1224 | 1384 | 1544 | . . . |
| 11 | 176 | 376 | 584 | 776 | 1000 | 1192 | 1384 | 1608 | 1800 | . . . |
| 12 | 208 | 440 | 680 | 904 | 1128 | 1352 | 1608 | 1800 | 2024 | . . . |
| 13 | 224 | 488 | 744 | 1000 | 1256 | 1544 | 1800 | 2024 | 2280 | . . . |
| 14 | 256 | 552 | 840 | 1128 | 1416 | 1736 | 1992 | 2280 | 2600 | . . . |
| 15 | 280 | 600 | 904 | 1224 | 1544 | 1800 | 2152 | 2472 | 2728 | . . . |
| 16 | 328 | 632 | 968 | 1288 | 1608 | 1928 | 2280 | 2600 | 2984 | . . . |
| 17 | 336 | 696 | 1064 | 1416 | 1800 | 2152 | 2536 | 2856 | 3240 | . . . |
| 18 | 376 | 776 | 1160 | 1544 | 1992 | 2344 | 2792 | 3112 | 3624 | . . . |
| 19 | 408 | 840 | 1288 | 1736 | 2152 | 2600 | 2984 | 3496 | 3880 | . . . |
| 20 | 440 | 904 | 1384 | 1864 | 2344 | 2792 | 3240 | 3752 | 4136 | . . . |
| 21 | 488 | 1000 | 1480 | 1992 | 2472 | 2984 | 3496 | 4008 | 4584 | . . . |
| 22 | 520 | 1064 | 1608 | 2152 | 2664 | 3240 | 3752 | 4264 | 4776 | . . . |
| 23 | 552 | 1128 | 1736 | 2280 | 2856 | 3496 | 4008 | 4584 | 5160 | . . . |
| 24 | 584 | 1192 | 1800 | 2408 | 2984 | 3624 | 4264 | 4968 | 5544 | . . . |
| 25 | 616 | 1256 | 1864 | 2536 | 3112 | 3752 | 4392 | 5160 | 5736 | . . . |
| 26 | 712 | 1480 | 2216 | 2984 | 3752 | 4392 | 5160 | 5992 | 6712 | . . . |

The LTE approach has a few problems, as described below.

Problem 1: The LTE TBS table was originally designed with specific assumption on the number of Resource Elements (REs) available within each allocated PRB as well as the number of OFDM symbols for data transmissions. When different transmission modes with different amount of reference symbol overheads were introduced later in LTE, it became difficult to define another TBS table to optimize for the new transmission modes. The companies in 3GPP at the end compromised by introducing a few new rows in the LTE TBS table to optimize for a few limited cases. That is, the explicit TBS table approach hinders continual evolution and improvement of the LTE system.

Problem 2: In the existing approach of determining the data block size does not provide high performance operation with different slot sizes or structures. This is well known problem in LTE system since a subframe in LTE may be of various sizes. A regular subframe may have different sizes of control region and thus leaves different sizes for the data region. TDD LTE supports different sizes in the downlink part (Downlink Pilot Time Slot (DwPTS)) of a TDD special subframe. Various different sizes of subframe are summarized in Table 3.

However, the LTE MCS and TBS tables are designed based on the assumption that 11 OFDM symbols are available for the data transmission. That is, when the actual number of available OFDM symbols for Physical Downlink Shared Channel (PDSCH) is different than 11, the spectral efficiency of the transmission will deviate from those shown in Table 4. First, notice that the code rate becomes excessively high when the actual number of OFDM symbols for PDSCH is substantially less than the assumed 11 symbols. These cases are highlighted with dark shades in Table 4. In LTE, the UE is not expected to decode any PDSCH transmission with an effective code rate higher than 0.930. Since the UE will not be able to decode such high code rates, transmissions based on these dark shaded MCSs will fail and retransmissions will be needed. Secondly, with the mismatch of radio resource assumption, code rates for some of the MCSs deviate out of the optimal range for the wideband wireless system. Based on extensive link performance evaluation for the downlink transmission as an example, the code rates for Quadrature Phase Shift Keying (QPSK) and 16 Quadrature Amplitude Modulation (16QAM) should not be higher than 0.70. Furthermore, the code rates for 16QAM and 64QAM should not be lower than 0.32 and 0.40, respectively. As illustrated with light shades, some of the MCSs in Table 4 result in sub-optimal code rate.

Since data throughput is reduced when transmissions are based on unsuitable or sub-optimal code rates, a good scheduling implementation in the base station should avoid using any shaded MCSs shown in Table 4. It can be concluded that the number of usable MCSs shrink significantly when the actual number of OFDM symbols for PDSCH deviates from the assumed 11 symbols.

TABLE 3
Available number of OFDM symbols for PDSCH ( N_{OS} ) in LTE

| | | Number of OFDM | | | |
|---|---|---|---|---|---|
| | | symbols for control | | | |
| Operation mode | | information | | | |
| FDD, TDD | Normal CP | 3 | 2 | 1 | 0 |
| | Extended CP | 1 | 0 | | |
| TDD DwPTS | configurations 1, 6 | | | | |
| normal CP | configurations 2, 7 | | | | |
| | configurations 3, 8 | 0 | | | |
| | configuration 4 | 1 | 0 | | |
| TDD DwPTS | configurations 1, 5 | | | | |
| extended CP | configurations 2, 6 | | | | |
| | configuration 3 | | | | |

TABLE 4
Code rate with different number of OFDM symbols for data transmission in LTE

| MCS | | | | | | | | | | |
|---|---|---|---|---|---|---|---|---|---|---|
| index | | Available number of OFDM symbols for PDSCH ( Nos ) | | | | | | | | |
| I_{MCS} | Modulation | 3 | 2 | 1 | 0 | | | | | |
| 0 | QPSK | 0.10 | 0.11 | 0.12 | 0.13 | 0.14 | 0.16 | 0.18 | 0.21 | 0.25 |
| 1 | QPSK | 0.13 | 0.14 | 0.16 | 0.17 | 0.19 | 0.21 | 0.24 | 0.28 | 0.34 |
| 2 | QPSK | 0.16 | 0.17 | 0.19 | 0.21 | 0.23 | 0.26 | 0.30 | 0.35 | 0.42 |
| 3 | QPSK | 0.21 | 0.22 | 0.25 | 0.27 | 0.30 | 0.34 | 0.39 | 0.45 | 0.54 |
| 4 | QPSK | 0.25 | 0.28 | 0.30 | 0.33 | 0.37 | 0.41 | 0.47 | 0.55 | 0.66 |
| 5 | QPSK | 0.31 | 0.34 | 0.37 | 0.41 | 0.45 | 0.51 | 0.58 | 0.68 | 0.81 |
| 6 | QPSK | 0.37 | 0.40 | 0.44 | 0.48 | 0.54 | 0.61 | 0.69 | 0.81 | 0.97 |
| 7 | QPSK | 0.44 | 0.47 | 0.52 | 0.57 | 0.63 | 0.71 | 0.81 | 0.94 | 1.13 |
| 8 | QPSK | 0.50 | 0.54 | 0.59 | 0.65 | 0.72 | 0.81 | 0.93 | 1.08 | 1.30 |
| 9 | QPSK | 0.56 | 0.61 | 0.67 | 0.73 | 0.81 | 0.91 | 1.05 | 1.22 | 1.46 |
| 10 | 16QAM | 0.28 | 0.30 | 0.33 | 0.37 | 0.41 | 0.46 | 0.52 | 0.61 | 0.73 |
| 11 | 16QAM | 0.31 | 0.34 | 0.37 | 0.41 | 0.45 | 0.51 | 0.58 | 0.68 | 0.81 |
| 12 | 16QAM | 0.36 | 0.39 | 0.43 | 0.47 | 0.52 | 0.58 | 0.67 | 0.78 | 0.94 |
| 13 | 16QAM | 0.40 | 0.44 | 0.48 | 0.53 | 0.58 | 0.66 | 0.75 | 0.88 | 1.05 |
| 14 | 16QAM | 0.46 | 0.50 | 0.54 | 0.59 | 0.66 | 0.74 | 0.85 | 0.99 | 1.19 |
| 15 | 16QAM | 0.51 | 0.55 | 0.60 | 0.66 | 0.74 | 0.83 | 0.95 | 1.10 | 1.33 |
| 16 | 16QAM | 0.54 | 0.59 | 0.64 | 0.71 | 0.79 | 0.88 | 1.01 | 1.18 | 1.41 |
| 17 | 64QAM | 0.36 | 0.39 | 0.43 | 0.47 | 0.52 | 0.59 | 0.67 | 0.79 | 0.94 |
| 18 | 64QAM | 0.39 | 0.42 | 0.46 | 0.50 | 0.56 | 0.63 | 0.72 | 0.83 | 1.00 |
| 19 | 64QAM | 0.43 | 0.46 | 0.51 | 0.56 | 0.62 | 0.69 | 0.79 | 0.93 | 1.11 |
| 20 | 64QAM | 0.47 | 0.51 | 0.55 | 0.61 | 0.68 | 0.76 | 0.87 | 1.01 | 1.22 |
| 21 | 64QAM | 0.51 | 0.55 | 0.60 | 0.66 | 0.74 | 0.83 | 0.95 | 1.10 | 1.32 |
| 22 | 64QAM | 0.55 | 0.60 | 0.65 | 0.72 | 0.79 | 0.89 | 1.02 | 1.19 | 1.43 |
| 23 | 64QAM | 0.59 | 0.64 | 0.70 | 0.77 | 0.86 | 0.96 | 1.10 | 1.29 | 1.54 |
| 24 | 64QAM | 0.64 | 0.69 | 0.75 | 0.83 | 0.92 | 1.04 | 1.18 | 1.38 | 1.66 |
| 25 | 64QAM | 0.68 | 0.74 | 0.80 | 0.88 | 0.98 | 1.10 | 1.26 | 1.47 | 1.77 |
| 26 | 64QAM | 0.72 | 0.78 | 0.85 | 0.94 | 1.04 | 1.17 | 1.34 | 1.56 | 1.88 |
| 27 | 64QAM | 0.75 | 0.81 | 0.89 | 0.98 | 1.09 | 1.22 | 1.40 | 1.63 | 1.95 |
| 28 | 64QAM | 0.88 | 0.95 | 1.04 | 1.15 | 1.27 | 1.43 | 1.64 | 1.91 | 2.29 |

Problem 3: As mentioned in above, the slot structure for NR tends to be more flexible with much larger range of the amount of allocated resource for UE to receive or transmit. The base of designing a TBS table diminishes significantly.

There is a need for systems and methods for determining TBS, e.g., for NR, in such a manner that addresses the problems discussed above.

### SUMMARY

A method performed by a transmitter or receiver includes determining an intermediate number of information bits, Ninfo, to be transmitted from a number of allocated physical resource blocks, PRB, a number of resource elements, RE, per PRB, a number of multiple input multiple output, MIMO layers, a modulation order and a target code rate for transmission of the information bits; quantizing the intermediate number of information bits as a first integer multiple of a second integer, where the second integer is equal to 2-to-the-power of a third integer, to provide a quantized intermediate number of information bits; determining a transport block size from the quantized intermediate number of information bits; and transmitting or receiving a transport block over a physical channel according to the determined transport block size. The third integer may be calculated as or based on a binary logarithm of the intermediate number of information bits, Ninfo. In some embodiments, the third integer may be set to zero if the binary logarithm of the intermediate number of information bits, Ninfo, may be less than a fourth integer.

In some embodiments, the fourth integer may be equal to five. In some embodiments, the third integer may be further obtained by calculating a binary logarithm of a linear function of Ninfo and basing the third integer on the calculated binary logarithm In some embodiments, the third integer may be further obtained by, and therefore based on calculating a floor of the binary logarithm of the linear function of Ninfo. In some embodiments, the third integer may be further adjusted by reducing the floor of the binary logarithm by the fourth integer.

In some embodiments, the first integer may be obtained using the intermediate number of information bits, Ninfo. In some embodiments, the first integer may be further obtained by using a round function.

In some embodiments, the first integer may be further obtained by using a round function of a variable that may be derived by dividing a linear function of Ninfo by the second integer.

In some embodiments, the physical channel may be a physical downlink shared channel. In some embodiments, the physical channel may be a physical uplink shared channel.

A radio node in a cellular communications network may be adapted to perform operations of determining an intermediate number of information bits, Ninfo, to be transmitted from a number of allocated physical resource blocks, PRB, a number of resource elements, RE, per PRB, a number of multiple input multiple output, MIMO layers, a modulation order and a target code rate for transmission of the information bits; quantizing the intermediate number of information bits as a first integer multiple of a second integer, where the second integer is equal to 2-to-the-power of a third integer, to provide a quantized intermediate number of information bits; determining a transport block size from the quantized intermediate number of information bits; and transmitting or receiving a transport block over a physical channel according to the determined transport block size. The third integer may be calculated as a binary logarithm of the intermediate number of information bits, Ninfo, and, in some embodiments, the third integer may be set to zero if the binary logarithm of the intermediate number of information bits, Ninfo, may be less than a fourth integer.

A radio node in a cellular communications network includes an interface operable to wirelessly transmit signals to and/or wirelessly receive signals from another node in the cellular communications network; and processing circuitry associated with the interface. The processing circuitry may be operable to perform operations of determining an intermediate number of information bits, Ninfo, to be transmitted from a number of allocated physical resource blocks, PRB, a number of resource elements, RE, per PRB, a number of multiple input multiple output, MIMO layers, a modulation order and a target code rate for transmission of the information bits; quantizing the intermediate number of information bits as a first integer multiple of a second integer, where the second integer is equal to 2-to-the-power of a third integer, to provide a quantized intermediate number of information bits; determining a transport block size from the quantized intermediate number of information bits; and transmitting or receiving a transport block over a physical channel according to the determined transport block size. The third integer may be calculated as a binary logarithm of the intermediate number of information bits, Ninfo, and, in some embodiments, the third integer may be set to zero if the binary logarithm of the intermediate number of information bits, Ninfo, may be less than a fourth integer.

In some embodiments, the radio node may be a base station. In some embodiments, the radio node may be a User Equipment, UE.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 shows a subframe with 14 Orthogonal Frequency Division Multiplexing (OFDM) symbols;

FIG. 2 illustrates potential slot variations;

FIG. 3 illustrates an example of a mini-slot;

FIG. 4A illustrates the operation of a User Equipment (UE) to determine and use a Transport Block Size (TBS) for downlink reception in accordance with some embodiments of the present disclosure;

FIG. 4B illustrates the operation of a base station to determine and use a TBS for downlink transmission in accordance with some embodiments of the present disclosure;

FIGS. 5A, 5B, and 5C are graphs of transport block size generated for various MIMO configurations according to some embodiments;

FIG. 5D is a graph illustrating differences between adjacent TBS generated according to some embodiments;

FIG. 5E is a graph illustrating proportion of differences between adjacent TBS generated according to some embodiments;

FIG. 6 illustrates an example wireless network;

FIG. 7 illustrates one embodiment of a UE in accordance with various aspects described herein;

FIG. 8 is a schematic block diagram illustrating a virtualization environment in which functions implemented by some embodiments may be virtualized;

FIG. 9 illustrates a telecommunication network connected via an intermediate network to a host computer in accordance with some embodiments;

FIG. 10 illustrates a host computer communicating via a base station with a UE over a partially wireless connection in accordance with some embodiments;

FIG. 11 is a flowchart illustrating a method implemented in a communication system in accordance with one embodiment;

FIG. 12 is a flowchart illustrating a method implemented in a communication system in accordance with one embodiment;

FIG. 13 is a flowchart illustrating a method implemented in a communication system in accordance with one embodiment;

FIG. 14 is a flowchart illustrating a method implemented in a communication system in accordance with one embodiment;

FIG. 15 depicts a method in accordance with particular embodiments; and

FIG. 16 illustrates a schematic block diagram of an apparatus in a wireless network (for example, the wireless network shown in FIG. 6).

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

In the present application, the terms User Equipment device (UE), terminal, handset, etc. are used interchangeably to denote the device that communicates with the infrastructure. The term should not be construed as to mean any specific type of device, it applies to them all, and the solutions described here are applicable to all devices that use the concerned solution to solve the problems as described. Similarly, a base station is intended to denote the node in the infrastructure that communicates with the UE. Different names may be applicable, and the functionality of the base station may also be distributed in various ways. For example, there could be a radio head terminating parts of the radio protocols and a centralized unit that terminates other parts of the radio protocols. We will not distinguish such implementations here; instead, the term base station will refer to all alternative architectures that can implement embodiments of the present disclosure.

Some of the embodiments contemplated herein will now be described more fully with reference to the accompanying drawings. Others, embodiments, however, are contained within the scope of the subject matter disclosed herein, and the disclosed subject matter should not be construed as limited to only the embodiments set forth herein; rather, these embodiments are provided by way of example to convey the scope of the subject matter to those skilled in the art.

To address the aforementioned problems associated with the Transport Block Size (TBS) determination scheme used in Long Term Evolution (LTE), suggestions have been made to determine the TBS through a formula instead of a table. One example where the TBS is determined as follows:

$$TBS = C \times ⌈ \frac{{N}_{PRB} \cdot {N}_{RE}^{DL , PRB} \cdot v \cdot {Q}_{m} \cdot R}{C} ⌉$$

where
ν is number of layers the codeword is mapped onto;
N_{RE}^{DL,PRB} is the number of Resource Elements (REs) per Physical Resource Block (PRB) per slot/mini-slot available for carrying the Physical Downlink Shared Channel (PDSCH);
N_{PRB} is the number of allocated PRBs;
modulation order, Qₘ, and target code rate, R, are read from a Modulation and Coding Scheme (MCS) table based on I_{MCS} signaled in the Downlink Control Information (DCI); and
an example value of C is 8, to ensure that TBS is a multiple of 8.

Here N_{PRB}, N_{RE}^{DL,PRB}, υ, Qₘ, R are signaled through DCI or are configured through higher layers. Other formulas are also possible.

In RAN1 #90bis, the following agreement is made to generate an “intermediate” number of information bits:

Calculate an “intermediate” number of information bits N_{RE}·υ·Qₘ·R where
υ is the number of layers,
Qₘ is the modulation order, obtained from the MCS index
R is the code rate, obtained from the MCS index
N_{RE} is number of resource elements
N_{RE}=Y*#PRBs_scheduled

When determining N_{RE} (number of REs) within a slot:
Determine X=12*#OFDM_symbols_scheduled−Xd−Xoh
Xd=#REs_for_DMRS_per_PRB in the scheduled duration
Xoh=accounts for overhead from CSI-RS, CORESET, etc. One value for UL, one for DL.
Xoh is semi-statically determined.

Quantize X into one of a predefined set of values, resulting in Y [8] values. This should allow for reasonable accuracy for all transmission durations, and may depend on the number of scheduled symbols.

The quantization of X may use a floor, ceiling or some other quantization function.

The quantization step should ensure the same TB size can be obtained between transmission and retransmission, irrespective of the number of layers used for the retransmission. otherwise Xd has to be independent of the number of layers.

The actual TB size may be obtained from the intermediate number of information bits according to the channel coding decisions.

A way of achieving equal size codeblocks when designing TBS for a single Low-Density Parity-Check (LDPC) base graph is to use formulas like the following. Consider the formula:

$$TBS = 8 \times ⌈ \frac{{N}_{PRB} \cdot {N}_{RE}^{DL , PRB} \cdot v \cdot {Q}_{m} \cdot R}{8} ⌉$$

This formula can be described as:

$$TBS = 8 \times ⌈ \frac{{TBS}_{0}}{8} ⌉$$

where TBS₀ is an approximation of the actual TBS determined according to scheduling resources, MCS, and Multiple Input Multiple Output (MIMO) configuration:

TBS₀=N_{PRB}·N_{RE}^{DL,PRB}·υ·Qₘ·R

In general, TBS₀ can determined via any formula for a desired approximate TBS. Another example of how to determine TBS₀ is to find it in a look-up table such as the LTE TBS table.

Assume that the number of codeblocks C is determined in the following manner, which is similar to LTE. The total number of codeblocks C is determined by:
If TBS+L₁≤Z
   Number of codeblocks: C=1
Else
   Number of codeblocks: C=[(TBS+L₂)/(Z−L₃)]
End if

If C=1, L₁ CRC bits are attached to each transport block. If C>1, L₂ CRC bits are attached to each transport block and L₃ additional Cyclic Redundancy Check (CRC) bits are attached to each codeblock after segmentation. Z is a maximum codeblock size including CRC bits. Some example values of L₁, L₂, and L₃ are 0, 8, 16, or 24. Some or all of L₁, L₂, and L₃ might be equal.

In one example, the TBS is determined as follows:

$$If C = 1$$

$$TBS = A \times ⌈ \frac{{TBS}_{0}}{A} ⌉$$

$$Else$$

$$TBS = C \times A \times ⌈ \frac{{TBS}_{0} + {L}_{2}}{C \times A} ⌉ - {L}_{2}$$

$$End if .$$

An example value of A is 8, to ensure that TBS is a multiple of 8. Another example value of A is 1.

In another example, the TBS is determined as follows:

$$If C = 1$$

$$TBS = A \times ⌈ \frac{{TBS}_{0}}{A} ⌉$$

$$Else$$

$$TBS = lcm ( C , A ) \times ⌈ \frac{{TBS}_{0} + {L}_{2}}{lcm ( C , A )} ⌉ - {L}_{2} \\ End if .$$

Here lcm(C, A) is the least common multiple of A and C. An example value of A is 8, to ensure that TBS is a multiple of 8. Another example value of A is 1.

If after adding any CRC bits, the transport block is larger than the largest possible codeblock size, the transport block needs to be segmented into several codeblocks. In LTE, this procedure is described in Third Generation Partnership Project (3GPP) Technical Specification (TS) 36.212 V13.2.0 (2016-06) Section 5.1.2. A similar procedure is likely to be adopted in New Radio (NR).

There are two sets of LDPC codes defined for NR. One set is designed for code rates from ˜8/9 to 1/3 and block lengths up to 8448 and is referred to as base graph #1, also called BG #1. The other set is defined for code rates from ˜2/3 to 1/5 and block lengths up to 3840 and is referred to as base graph #2 or BG #2. When these LDPC codes are used with lower rates than that for which they were designed, repetition and chase combining is used to achieve a lower code rate.

There currently exist certain challenge(s). In particular, due to the large number of possible parameter combinations in NR, there is a large number of possible values of Ninfo, where N_{info} is the intermediate number of information bits. When using Ninfo directly to determine TB size (TBS) according to existing agreements, it results in a large number of possible values of TBS. As a consequence, each TBS value is associated with a small number of different configurations. This makes it difficult to schedule for the same TBS during retransmission, if the retransmission uses a different configuration than the initial transmission.

Certain aspects of the present disclosure and their embodiments may provide solutions to the aforementioned problems or other challenges. In one embodiment, Ninfo is quantized before the TBS determination procedure that considers code block segmentation is applied. The quantization uses power-of-2 as grids.

Certain embodiments may provide one or more of the following technical advantage(s). Using the quantization of N_{info}, the number of possible values of TBS is reduced significantly. As a consequence, each TBS value is associated with a larger number of configurations. This makes it easier to schedule for the same TBS during retransmission, where the retransmission may use a different configuration than the initial transmission. With more scheduling flexibility for the retransmissions, there is a higher chance that an MCS index and resource allocation closer to the desired can be selected. This in turn improves the overall system throughput.

Quantization of N_{info} for TBS Determination

In this discussion, it is assumed the full transport block is transmitted or re-transmitted.

The transport block size is calculated from the intermediate number of information bits, which in turn depends on the resource allocation, MCS, and number of MIMO layers. In the following we denote the intermediate number of information bits, i.e. the approximate TB size, by N_{info}. How the TBS is determined from N_{info} depends on if both or only one of the base graphs are implemented in transmitter and receiver.

For calculating an intermediate number of information bits, N_{info}, several parameters are to be defined.

Xoh: the set of possible values to configure need to be defined. The set of possible values for Xoh need to consider slot vs mini-slot, DL vs UL. It is not crucial to have many values to set for Xoh, since quantization is applied to Y. The set of Y values affect N_{info} more directly than Xoh. We propose the following:

For DL, a good estimate is: Xoh=6 (RE) if the number of OFDM symbols scheduled is fewer than 7, otherwise Xoh=12 (RE).

For UL, Xoh=12 or 24 (RE)

Y: The set of Y values would determine the set of values of N_{info}. We propose the following set of 8 values considering mini-slots and slots, DL and UL.

Y=12*[2 4 6 7 8 10 11 12]

Together with the steps carried out for LDPC, the TBS is determined using the following procedure:

Step 1: Calculate the intermediate number of information bits Ninfo by:

N_{info}=N_{PRB}·N_{RE}^{DL,PRB}·υ·Qₘ·R

Step 2: Round the intermediate number of information bits N_{info} to the closest multiple of 2ⁿ:

$${TBS}_{0} = {2}^{n} \times round ( \frac{{N}_{info}}{{2}^{n}} )$$

$$where$$

$$n = \{ \begin{matrix}⌊ {log}_{2} {N}_{info} ⌋ - 5 & if {log}_{2} {N}_{info} > 5 \\ 0 & if {log}_{2} {N}_{info} \leq 5\end{matrix}$$

That is, the value of n is calculated based on a linear function of a binary logarithm of the intermediate number of information bits, N_{info}. In particular, the value of n is calculated as a linear function of the binary logarithm of the intermediate number of information bits, N_{info}, that is obtained by subtracting an integer value from the binary logarithm of N_{info}. The value of n is set to zero if the binary logarithm of the intermediate number of information bits, N_{info}, is less than the integer value by which the binary logarithm of N_{info} was reduced. In particular embodiments, the integer value is equal to five. As shown below, this approach has shown to have good performance for low values of N_{info}.

Step 3: Further adjust TBS₀ to final TBS value for MAC layer, TBS₁, where TBS₁ can be segmented into integer number of byte-aligned code blocks when BG #1 is assumed.

It is noted that the calculation of the intermediate number of information bits, N_{info}, applies to both UL (i.e., PUSCH, or Physical uplink shared channel) and DL (i.e., PDSCH, or Physical downlink shared channel). Similarly, the Step 1-Step 3 above apply to both PDSCH and PUSCH.

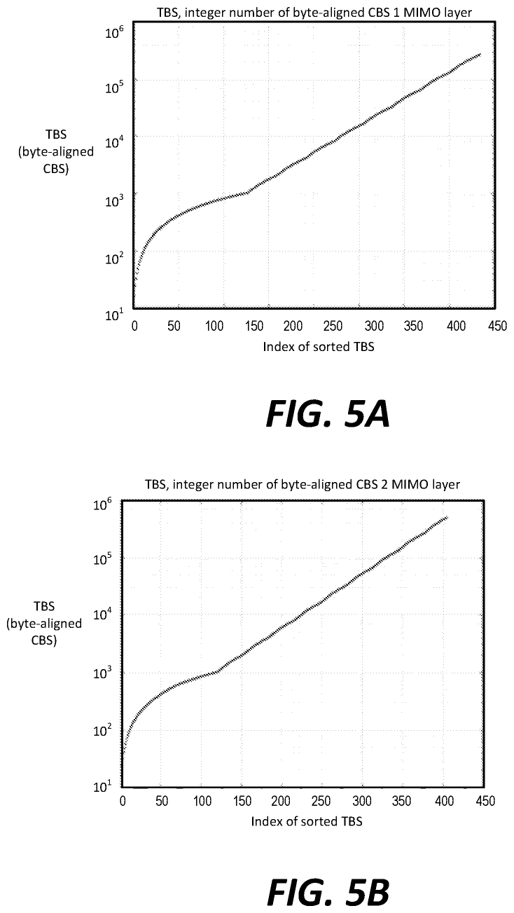

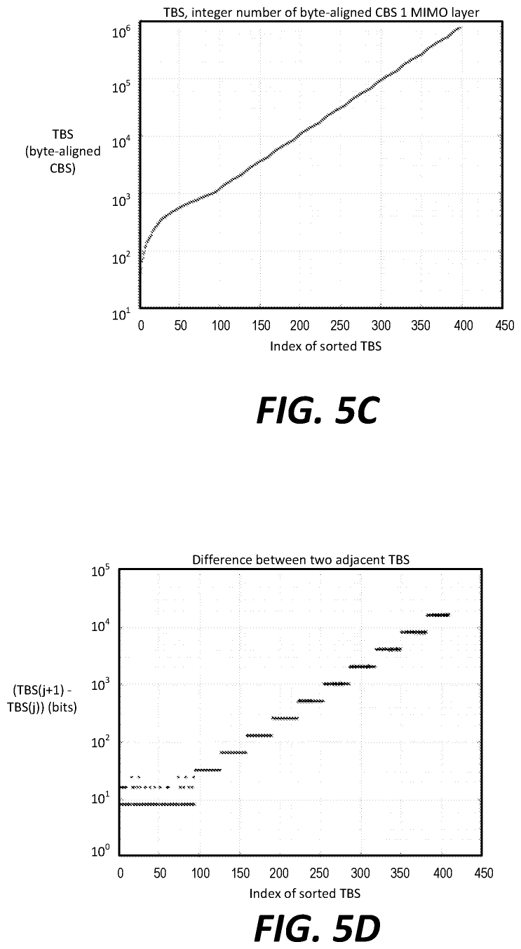

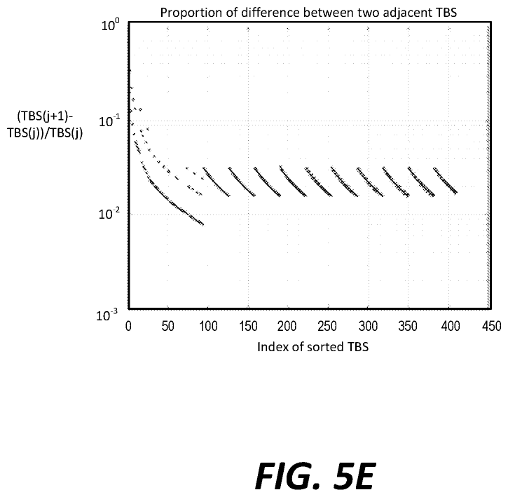

When considering 1, 2, and 4 MIMO layers for TBS, the TBS₁ distribution is shown in FIG. 5A. The difference between two adjacent TBS₁ values are shown in FIG. 5B. FIG. 5C demonstrates that due to the rounding by 2ⁿ, the relative difference between two adjacent TBS₁ is at most 3% for larger TBS.

Based on the above discussion, the following approach is provided.

The set of Y values has 8 values: 12*[2 4 6 7 8 10 11 12].

The intermediate number of information bits N_{info} is rounded to the closest multiple of 2ⁿ to reduce the number of TBS values used in scheduling.

The TBS determination is a formula-based approach that takes N_{info} as given above as an input and outputs a final TBS that is byte-aligned and gives equal-sized code blocks after code block segmentation. The agreement that determines which base graph to use depending on the rate of the initial transmission determines which maximum code block size to use when calculating the TBS so that the code blocks are equal-sized after segmentation.

Following are additional details regarding step 2 and step 3 above.

Step 2:

Even though TBS in NR is determined by a formula, it is important to have a coarse grid of allowed TB sizes, like in LTE. In LTE, the maximum TBS found in the TBS tables is 391,656 bits and the total number of unique allowed TB sizes is 237. The reason for having a coarse TBS grid is to make it possible to schedule a retransmission such that the control information of the retransmission corresponds to the same TBS as in the initial transmission also when there are small changes in the allocation or MCS index, as described above.

Step 3:

According to the agreement, the method ensures that all allowed TB sizes are multiples of the number of code blocks when performing code block segmentation. This ensures that no zero padding is necessary with BG 1 or BG 2 segmentation. The procedure below describes how TBS is determined from TBS₀ and selected base graph:

```
If base graph #1 is selected
If TBS₀ + L₁ ≤ Z₁
  Number of code blocks: C = 1
  $Transport block \text{size:} {TBS}_{1} = 8 \cdot ⌈ \frac{T B {S}_{0}}{8} ⌉$
  else
  Number of code blocks: C = ┌(TBS₀ + L₁)/(Z₁ − L₂)┐
  $Transport block \text{size:} TB {S}_{1} = 8 \times C \cdot ⌈ \frac{T B {S}_{0} + {L}_{1}}{8 \times C} ⌉ - {L}_{1}$
  end
else
  If TBS₀ + L₀ ≤ Z₂
  Number of code blocks: C = 1
  $Transport block \text{size:} TB {S}_{1} = 8 \cdot ⌈ \frac{T B {S}_{0}}{8} ⌉$
  else
  Number of code blocks: C = ┌(TBS₀ + L₁)/(Z₂ − L₂)┐
  $Transport block \text{size:} TB {S}_{1} = 8 \times C \cdot ⌈ \frac{T B {S}_{0} + {L}_{1}}{8 \times C} ⌉ - {L}_{1}$
  end
end
```

with L₁=L₂=24, L₀=16, Z₁=8448, Z₂=3840. The multiplication and division by 8×C in the TBS calculation ensure equal-sized byte-aligned CBS, and thereby also byte-aligned TBS.

To avoid circular relations between TBS determination and base graph selection, base graph selection is based on the intermediate number of information bits instead of the TBS.

Validation of Transport Block Size Determination

In this section, the TBS determination procedure is validated by showing the set of TB sizes that may occur as well as the relative difference between allowed TB sizes. FIGS. 5A, 5B and 5C show the TB sizes that occur for 1, 2 and 4 MIMO layers, respectively. In the figures shown in this section, the intermediate number of information bits N_{info} has been determined as

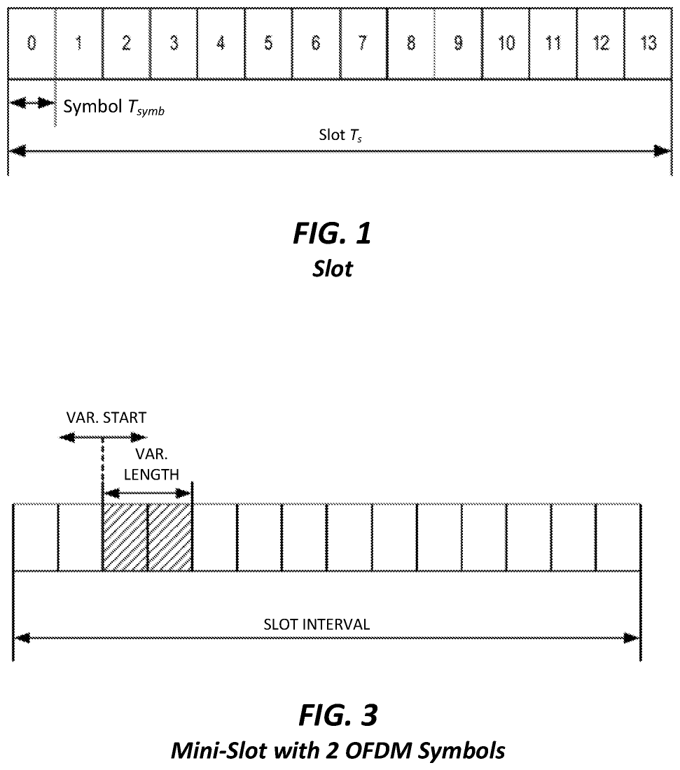

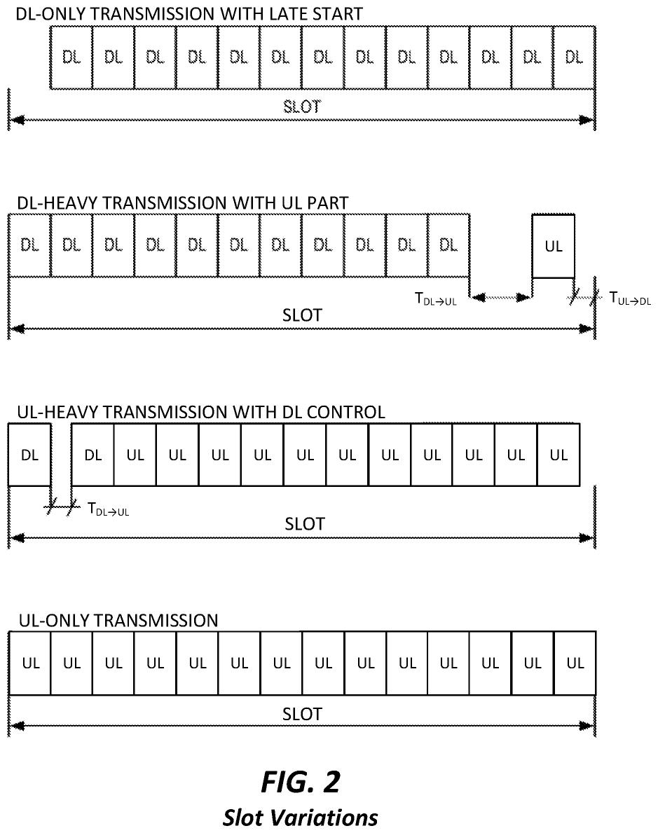

N_{info}=N_{PRB}·N_{RE}^{DL,PRB}·υ·Qₘ·R

where
ν is fixed to the number of MIMO layers shown in the respective figure,
N_{RE}^{DL,PRB} can take a range of values, considering the number of OFDM symbols occupied, overhead due to CORESET, DMRS, etc. In the test of FIG. 1-3,
N_{RE}^{DL,PRB} is assumed to between 24 and 144;
N_{PRB} ranges between 1 and 275,
Qₘ, and target code rate, R, take values from the MCS table in the appendix.

The TBS has then been determined from N_{info} as described above. The figures show that the TBS that occur covers the full range of N_{info} values.

We now consider TB sizes that occur when the number of MIMO layers spans the range from 1 to 4. 5D shows the difference between two adjacent TB sizes and shows that with the proposed formula for determining TBS, the TBS are regularly spaced with increasing difference for large TBS. In addition, FIG. 5E shows that the proportion of difference between two adjacent TB, calculated as (TBSⱼ₊₁−TBSⱼ)/TBSⱼ, is around 1% or less even though equal-sized and byte-aligned CBS has been enforced for BG 1.

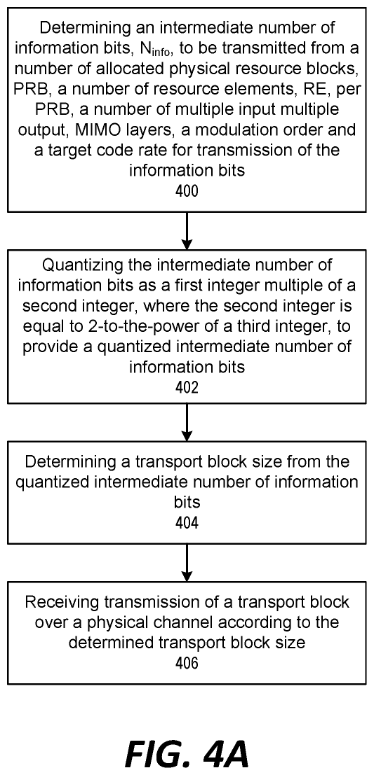

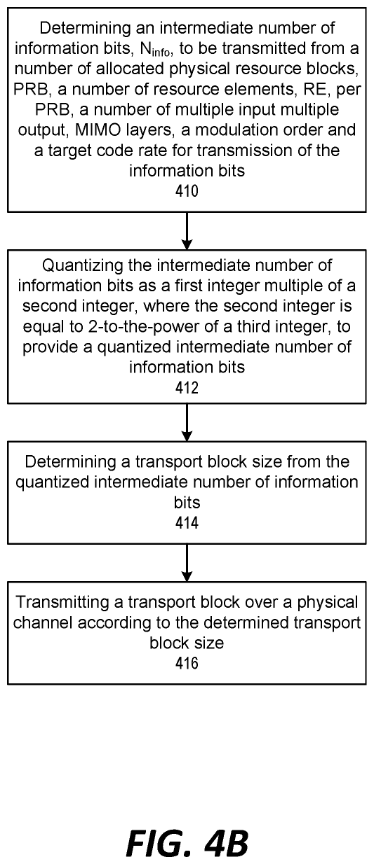

Systems and methods are described herein for determining TBS. In particular, a radio node determines a TBS for a transmission of a physical channel and transmits or receives the transmission in accordance with the determined TBS. In this regard, FIG. 4A illustrates an example in which a radio node determines a TBS for a transmission of a physical channel and receives the transmission in accordance with the determined TBS. The radio node may be a UE, and the physical channel may be a physical downlink channel. Alternatively, radio node may be a base station (gNodeB), and the physical channel may be a physical uplink channel.

Referring to FIG. 4A, in some embodiments, the operations include determining an intermediate number of information bits, Ninfo, to be transmitted from a number of allocated physical resource blocks, PRB, a number of resource elements, RE, per PRB, a number of multiple input multiple output, MIMO layers, a modulation order and a target code rate for transmission of the information bits (block 400), quantizing the intermediate number of information bits as a first integer multiple of a second integer, where the second integer is equal to 2-to-the-power of a third integer, to provide a quantized intermediate number of information bits (block 402), determining a transport block size from the quantized intermediate number of information bits (block 404); and receiving transmission of a transport block over a physical channel according to the determined transport block size (block 406) The third integer is calculated as a binary logarithm of the intermediate number of information bits, Ninfo, and is set to zero if the binary logarithm of the intermediate number of information bits, Ninfo, is less than a fourth integer.

FIG. 4B illustrates an example in which a radio node determines a TBS for a transmission of a physical channel and transmits the transmission in accordance with the determined TBS. The radio node may be a UE, and the physical channel may be a physical uplink channel. Alternatively, radio node may be a base station (gNodeB), and the physical channel may be a physical downlink channel.

Referring to FIG. 4B, in some embodiments, the operations include determining an intermediate number of information bits, Ninfo, to be transmitted from a number of allocated physical resource blocks, PRB, a number of resource elements, RE, per PRB, a number of multiple input multiple output, MIMO layers, a modulation order and a target code rate for transmission of the information bits (block 410), quantizing the intermediate number of information bits as a first integer multiple of a second integer, where the second integer is equal to 2-to-the-power of a third integer, to provide a quantized intermediate number of information bits (block 412), determining a transport block size from the quantized intermediate number of information bits (block 414); and transmitting a transport block over a physical channel according to the determined transport block size (block 416) The third integer is calculated as a binary logarithm of the intermediate number of information bits, Ninfo, and is set to zero if the binary logarithm of the intermediate number of information bits, Ninfo, is less than a fourth integer.

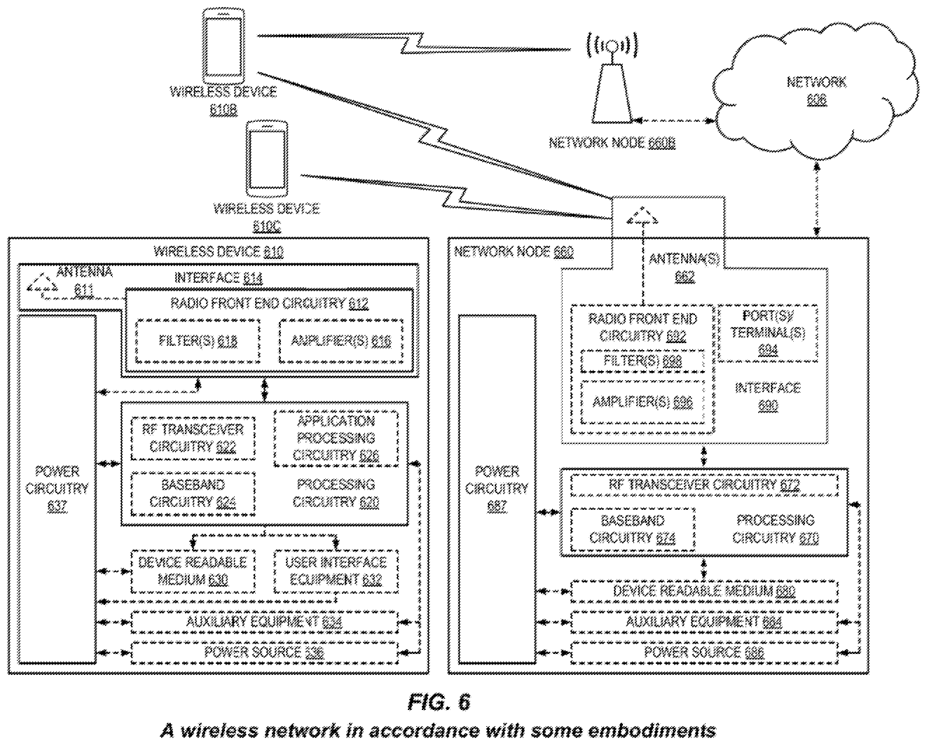

Although the subject matter described herein may be implemented in any appropriate type of system using any suitable components, the embodiments disclosed herein are described in relation to a wireless network, such as the example wireless network illustrated in FIG. 6. For simplicity, the wireless network of FIG. 6 only depicts network 606, network nodes 660 and 660B, and WDs 610, 610B, and 610C. In practice, a wireless network may further include any additional elements suitable to support communication between wireless devices or between a wireless device and another communication device, such as a landline telephone, a service provider, or any other network node or end device. Of the illustrated components, network node 660 and Wireless Device (WD) 610 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), LTE, and/or other suitable Second, Third, Forth, or Fifth Generation (2G, 3G, 4G, or 5G) standards; Wireless Local Area Network (WLAN) standards, such as the IEEE 802.11 standards; and/or any other appropriate wireless communication standard, such as the Worldwide Interoperability for Microwave Access (WiMax), Bluetooth, Z-Wave, and/or ZigBee standards.

Network 606 may comprise one or more backhaul networks, core networks, Internet Protocol (IP) networks, Public Switched Telephone Networks (PSTNs), packet data networks, optical networks, Wide Area Networks (WANs), Local Area Networks (LANs), WLANs, wired networks, wireless networks, metropolitan area networks, and other networks to enable communication between devices.

Network node 660 and WD 610 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, Access Points (APs) (e.g., radio access points), Base Stations (BSs) (e.g., radio base stations, Node Bs, enhanced or evolved Node Bs (eNBs) and NR base stations (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or Remote Radio Units (RRUs), sometimes referred to as Remote Radio Heads (RRHs). Such remote radio units may or may not be integrated with an antenna as an antenna integrated radio. Parts of a distributed radio base station may also be referred to as nodes in a Distributed Antenna System (DAS). Yet further examples of network nodes include Multi-Standard Radio (MSR) equipment such as MSR BSs, network controllers such as Radio Network Controllers (RNCs) or Base Station Controllers (BSCs), Base Transceiver Stations (BTSs), transmission points, transmission nodes, Multi-Cell/Multicast Coordination Entities (MCEs), core network nodes (e.g., Mobile Switching Centers (MSCs), Mobility Management Entity (MMEs)), Operation and Maintenance (O&M) nodes, Operations Support System (OSS) nodes, Self-Organizing Network (SON) nodes, positioning nodes (e.g., Evolved Serving Mobile Location Center (E-SMLCs)), and/or Minimization of Drive Tests (MDTs). As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 6, network node 660 includes processing circuitry 670, device readable medium 680, interface 690, auxiliary equipment 684, power source 686, power circuitry 687, and antenna 662. Although network node 660 illustrated in the example wireless network of FIG. 6 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 660 are depicted as single boxes located within a larger box, or nested within multiple boxes, in practice, a network node may comprise multiple different physical components that make up a single illustrated component (e.g., device readable medium 680 may comprise multiple separate hard drives as well as multiple Random Access Memory (RAM) modules).

Similarly, network node 660 may be composed of multiple physically separate components (e.g., a Node B component and a RNC component, or a BTS component and a BSC component, etc.), which may each have their own respective components. In certain scenarios in which network node 660 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, network node 660 may be configured to support multiple Radio Access Technologies (RATs). In such embodiments, some components may be duplicated (e.g., separate device readable medium 680 for the different RATs) and some components may be reused (e.g., the same antenna 662 may be shared by the RATs). Network node 660 may also include multiple sets of the various illustrated components for different wireless technologies integrated into network node 660, such as, for example, GSM, WCDMA, LTE, NR, WiFi, or Bluetooth wireless technologies. These wireless technologies may be integrated into the same or different chip or set of chips and other components within network node 660.

Processing circuitry 670 is configured to perform any determining, calculating, or similar operations (e.g., certain obtaining operations) described herein as being provided by a network node. These operations performed by processing circuitry 670 may include processing information obtained by processing circuitry 670 by, for example, converting the obtained information into other information, comparing the obtained information or converted information to information stored in the network node, and/or performing one or more operations based on the obtained information or converted information, and as a result of said processing making a determination.

Processing circuitry 670 may comprise a combination of one or more of a microprocessor, controller, microcontroller, Central Processing Unit (CPU), Digital Signal Processor (DSP), Application Specific Integrated Circuit (ASIC), Field Programmable Gate Array (FPGA), or any other suitable computing device, resource, or combination of hardware, software and/or encoded logic operable to provide, either alone or in conjunction with other network node 660 components, such as device readable medium 680, network node 660 functionality. For example, processing circuitry 670 may execute instructions stored in device readable medium 680 or in memory within processing circuitry 670. Such functionality may include providing any of the various wireless features, functions, or benefits discussed herein. In some embodiments, processing circuitry 670 may include a System on a Chip (SOC).

In some embodiments, processing circuitry 670 may include one or more of Radio Frequency (RF) transceiver circuitry 672 and baseband processing circuitry 674. In some embodiments, RF transceiver circuitry 672 and baseband processing circuitry 674 may be on separate chips (or sets of chips), boards, or units, such as radio units and digital units. In alternative embodiments, part or all of RF transceiver circuitry 672 and baseband processing circuitry 674 may be on the same chip or set of chips, boards, or units.

In certain embodiments, some or all of the functionality described herein as being provided by a network node, base station, eNB or other such network device may be performed by processing circuitry 670 executing instructions stored on device readable medium 680 or memory within processing circuitry 670. In alternative embodiments, some or all of the functionality may be provided by processing circuitry 670 without executing instructions stored on a separate or discrete device readable medium, such as in a hard-wired manner In any of those embodiments, whether executing instructions stored on a device readable storage medium or not, processing circuitry 670 can be configured to perform the described functionality. The benefits provided by such functionality are not limited to processing circuitry 670 alone or to other components of network node 660, but are enjoyed by network node 660 as a whole, and/or by end users and the wireless network generally.

Device readable medium 680 may comprise any form of volatile or non-volatile computer readable memory including, without limitation, persistent storage, solid-state memory, remotely mounted memory, magnetic media, optical media, RAM, Read Only Memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 670. Device readable medium 680 may store any suitable instructions, data or information, including a computer program, software, an application including one or more of logic, rules, code, tables, etc. and/or other instructions capable of being executed by processing circuitry 670 and, utilized by network node 660. Device readable medium 680 may be used to store any calculations made by processing circuitry 670 and/or any data received via interface 690. In some embodiments, processing circuitry 670 and device readable medium 680 may be considered to be integrated.

Interface 690 is used in the wired or wireless communication of signaling and/or data between network node 660, network 606, and/or WDs 610. As illustrated, interface 690 comprises port(s)/terminal(s) 694 to send and receive data, for example to and from network 606 over a wired connection. Interface 690 also includes radio front end circuitry 692 that may be coupled to, or in certain embodiments a part of, antenna 662. Radio front end circuitry 692 comprises filters 698 and amplifiers 696. Radio front end circuitry 692 may be connected to antenna 662 and processing circuitry 670. Radio front end circuitry may be configured to condition signals communicated between antenna 662 and processing circuitry 670. Radio front end circuitry 692 may receive digital data that is to be sent out to other network nodes or WDs via a wireless connection. Radio front end circuitry 692 may convert the digital data into a radio signal having the appropriate channel and bandwidth parameters using a combination of filters 698 and/or amplifiers 696. The radio signal may then be transmitted via antenna 662. Similarly, when receiving data, antenna 662 may collect radio signals which are then converted into digital data by radio front end circuitry 692. The digital data may be passed to processing circuitry 670. In other embodiments, the interface may comprise different components and/or different combinations of components.

In certain alternative embodiments, network node 660 may not include separate radio front end circuitry 692, instead, processing circuitry 670 may comprise radio front end circuitry and may be connected to antenna 662 without separate radio front end circuitry 692. Similarly, in some embodiments, all or some of RF transceiver circuitry 672 may be considered a part of interface 690. In still other embodiments, interface 690 may include one or more ports or terminals 694, radio front end circuitry 692, and RF transceiver circuitry 672, as part of a radio unit (not shown), and interface 690 may communicate with baseband processing circuitry 674, which is part of a digital unit (not shown).

Antenna 662 may include one or more antennas, or antenna arrays, configured to send and/or receive wireless signals. Antenna 662 may be coupled to radio front end circuitry 690 and may be any type of antenna capable of transmitting and receiving data and/or signals wirelessly. In some embodiments, antenna 662 may comprise one or more omni-directional, sector or panel antennas operable to transmit/receive radio signals between, for example, 2 gigahertz (GHz) and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 662 may be separate from network node 660 and may be connectable to network node 660 through an interface or port.

Antenna 662, interface 690, and/or processing circuitry 670 may be configured to perform any receiving operations and/or certain obtaining operations described herein as being performed by a network node. Any information, data and/or signals may be received from a wireless device, another network node and/or any other network equipment. Similarly, antenna 662, interface 690, and/or processing circuitry 670 may be configured to perform any transmitting operations described herein as being performed by a network node. Any information, data and/or signals may be transmitted to a wireless device, another network node and/or any other network equipment.

Power circuitry 687 may comprise, or be coupled to, power management circuitry and is configured to supply the components of network node 660 with power for performing the functionality described herein. Power circuitry 687 may receive power from power source 686. Power source 686 and/or power circuitry 687 may be configured to provide power to the various components of network node 660 in a form suitable for the respective components (e.g., at a voltage and current level needed for each respective component). Power source 686 may either be included in, or external to, power circuitry 687 and/or network node 660. For example, network node 660 may be connectable to an external power source (e.g., an electricity outlet) via an input circuitry or interface such as an electrical cable, whereby the external power source supplies power to power circuitry 687. As a further example, power source 686 may comprise a source of power in the form of a battery or battery pack which is connected to, or integrated in, power circuitry 687. The battery may provide backup power should the external power source fail. Other types of power sources, such as photovoltaic devices, may also be used.

Alternative embodiments of network node 660 may include additional components beyond those shown in FIG. 6 that may be responsible for providing certain aspects of the network node's functionality, including any of the functionality described herein and/or any functionality necessary to support the subject matter described herein. For example, network node 660 may include user interface equipment to allow input of information into network node 660 and to allow output of information from network node 660. This may allow a user to perform diagnostic, maintenance, repair, and other administrative functions for network node 660.

As used herein, WD refers to a device capable, configured, arranged and/or operable to communicate wirelessly with network nodes and/or other wireless devices. Unless otherwise noted, the term WD may be used interchangeably herein with UE. Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a Voice over IP (VoIP) phone, a wireless local loop phone, a desktop computer, a Personal Digital Assistant (PDA), a wireless cameras, a gaming console or device, a music storage device, a playback appliance, a wearable terminal device, a wireless endpoint, a mobile station, a tablet, a laptop, a Laptop Embedded Equipment (LEE), a Laptop Mounted Equipment (LME), a smart device, a wireless Customer Premise Equipment (CPE), a vehicle-mounted wireless terminal device, etc. A WD may support Device-to-Device (D2D) communication, for example by implementing a 3GPP standard for sidelink communication, Vehicle-to-Vehicle (V2V), Vehicle-to-Infrastructure (V2I), Vehicle-to-Everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a Machine-to-Machine (M2M) device, which may in a 3GPP context be referred to as a Machine Type Communication (MTC) device. As one particular example, the WD may be a UE implementing the 3GPP Narrowband IoT (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 610 includes antenna 611, interface 614, processing circuitry 620, device readable medium 630, user interface equipment 632, auxiliary equipment 634, power source 636 and power circuitry 637. WD 610 may include multiple sets of one or more of the illustrated components for different wireless technologies supported by WD 610, such as, for example, GSM, WCDMA, LTE, NR, WiFi, WiMAX, or Bluetooth wireless technologies, just to mention a few. These wireless technologies may be integrated into the same or different chips or set of chips as other components within WD 610.

Antenna 611 may include one or more antennas or antenna arrays, configured to send and/or receive wireless signals, and is connected to interface 614. In certain alternative embodiments, antenna 611 may be separate from WD 610 and be connectable to WD 610 through an interface or port. Antenna 611, interface 614, and/or processing circuitry 620 may be configured to perform any receiving or transmitting operations described herein as being performed by a WD. Any information, data and/or signals may be received from a network node and/or another WD. In some embodiments, radio front end circuitry and/or antenna 611 may be considered an interface.

As illustrated, interface 614 comprises radio front end circuitry 612 and antenna 611. Radio front end circuitry 612 comprise one or more filters 618 and amplifiers 616. Radio front end circuitry 614 is connected to antenna 611 and processing circuitry 620, and is configured to condition signals communicated between antenna 611 and processing circuitry 620. Radio front end circuitry 612 may be coupled to or a part of antenna 611. In some embodiments, WD 610 may not include separate radio front end circuitry 612; rather, processing circuitry 620 may comprise radio front end circuitry and may be connected to antenna 611. Similarly, in some embodiments, some or all of RF transceiver circuitry 622 may be considered a part of interface 614. Radio front end circuitry 612 may receive digital data that is to be sent out to other network nodes or WDs via a wireless connection. Radio front end circuitry 612 may convert the digital data into a radio signal having the appropriate channel and bandwidth parameters using a combination of filters 618 and/or amplifiers 616. The radio signal may then be transmitted via antenna 611. Similarly, when receiving data, antenna 611 may collect radio signals which are then converted into digital data by radio front end circuitry 612. The digital data may be passed to processing circuitry 620. In other embodiments, the interface may comprise different components and/or different combinations of components.

Processing circuitry 620 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other WD 610 components, such as device readable medium 630, WD 610 functionality. Such functionality may include providing any of the various wireless features or benefits discussed herein. For example, processing circuitry 620 may execute instructions stored in device readable medium 630 or in memory within processing circuitry 620 to provide the functionality disclosed herein.

As illustrated, processing circuitry 620 includes one or more of RF transceiver circuitry 622, baseband processing circuitry 624, and application processing circuitry 626. In other embodiments, the processing circuitry may comprise different components and/or different combinations of components. In certain embodiments processing circuitry 620 of WD 610 may comprise a SOC. In some embodiments, RF transceiver circuitry 622, baseband processing circuitry 624, and application processing circuitry 626 may be on separate chips or sets of chips. In alternative embodiments, part or all of baseband processing circuitry 624 and application processing circuitry 626 may be combined into one chip or set of chips, and RF transceiver circuitry 622 may be on a separate chip or set of chips. In still alternative embodiments, part or all of RF transceiver circuitry 622 and baseband processing circuitry 624 may be on the same chip or set of chips, and application processing circuitry 626 may be on a separate chip or set of chips. In yet other alternative embodiments, part or all of RF transceiver circuitry 622, baseband processing circuitry 624, and application processing circuitry 626 may be combined in the same chip or set of chips. In some embodiments, RF transceiver circuitry 622 may be a part of interface 614. RF transceiver circuitry 622 may condition RF signals for processing circuitry 620.

In certain embodiments, some or all of the functionality described herein as being performed by a WD or UE may be provided by processing circuitry 620 executing instructions stored on device readable medium 630, which in certain embodiments may be a computer-readable storage medium. In alternative embodiments, some or all of the functionality may be provided by processing circuitry 620 without executing instructions stored on a separate or discrete device readable storage medium, such as in a hard-wired manner In any of those particular embodiments, whether executing instructions stored on a device readable storage medium or not, processing circuitry 620 can be configured to perform the described functionality. The benefits provided by such functionality are not limited to processing circuitry 620 alone or to other components of WD 610, but are enjoyed by WD 610 as a whole, and/or by end users and the wireless network generally.

Processing circuitry 620 may be configured to perform any determining, calculating, or similar operations (e.g., certain obtaining operations) described herein as being performed by a WD. These operations, as performed by processing circuitry 620, may include processing information obtained by processing circuitry 620 by, for example, converting the obtained information into other information, comparing the obtained information or converted information to information stored by WD 610, and/or performing one or more operations based on the obtained information or converted information, and as a result of said processing making a determination.

Device readable medium 630 may be operable to store a computer program, software, an application including one or more of logic, rules, code, tables, etc. and/or other instructions capable of being executed by processing circuitry 620. Device readable medium 630 may include computer memory (e.g., RAM or ROM), mass storage media (e.g., a hard disk), removable storage media (e.g., a CD or a DVD), and/or any other volatile or non-volatile, non-transitory device readable and/or computer executable memory devices that store information, data, and/or instructions that may be used by processing circuitry 620. In some embodiments, processing circuitry 620 and device readable medium 630 may be considered to be integrated.

User interface equipment 632 may provide components that allow for a human user to interact with WD 610. Such interaction may be of many forms, such as visual, audial, tactile, etc. User interface equipment 632 may be operable to produce output to the user and to allow the user to provide input to WD 610. The type of interaction may vary depending on the type of user interface equipment 632 installed in WD 610. For example, if WD 610 is a smart phone, the interaction may be via a touch screen; if WD 610 is a smart meter, the interaction may be through a screen that provides usage (e.g., the number of gallons used) or a speaker that provides an audible alert (e.g., if smoke is detected). User interface equipment 632 may include input interfaces, devices and circuits, and output interfaces, devices and circuits. User interface equipment 632 is configured to allow input of information into WD 610, and is connected to processing circuitry 620 to allow processing circuitry 620 to process the input information. User interface equipment 632 may include, for example, a microphone, a proximity or other sensor, keys/buttons, a touch display, one or more cameras, a USB port, or other input circuitry. User interface equipment 632 is also configured to allow output of information from WD 610, and to allow processing circuitry 620 to output information from WD 610. User interface equipment 632 may include, for example, a speaker, a display, vibrating circuitry, a Universal Serial Bus (USB) port, a headphone interface, or other output circuitry. Using one or more input and output interfaces, devices, and circuits, of user interface equipment 632, WD 610 may communicate with end users and/or the wireless network, and allow them to benefit from the functionality described herein.

Auxiliary equipment 634 is operable to provide more specific functionality which may not be generally performed by WDs. This may comprise specialized sensors for doing measurements for various purposes, interfaces for additional types of communication such as wired communications etc. The inclusion and type of components of auxiliary equipment 634 may vary depending on the embodiment and/or scenario.

Power source 636 may, in some embodiments, be in the form of a battery or battery pack. Other types of power sources, such as an external power source (e.g., an electricity outlet), photovoltaic devices or power cells, may also be used. WD 610 may further comprise power circuitry 637 for delivering power from power source 636 to the various parts of WD 610 which need power from power source 636 to carry out any functionality described or indicated herein. Power circuitry 637 may in certain embodiments comprise power management circuitry. Power circuitry 637 may additionally or alternatively be operable to receive power from an external power source; in which case WD 610 may be connectable to the external power source (such as an electricity outlet) via input circuitry or an interface such as an electrical power cable. Power circuitry 637 may also in certain embodiments be operable to deliver power from an external power source to power source 636. This may be, for example, for the charging of power source 636. Power circuitry 637 may perform any formatting, converting, or other modification to the power from power source 636 to make the power suitable for the respective components of WD 610 to which power is supplied.

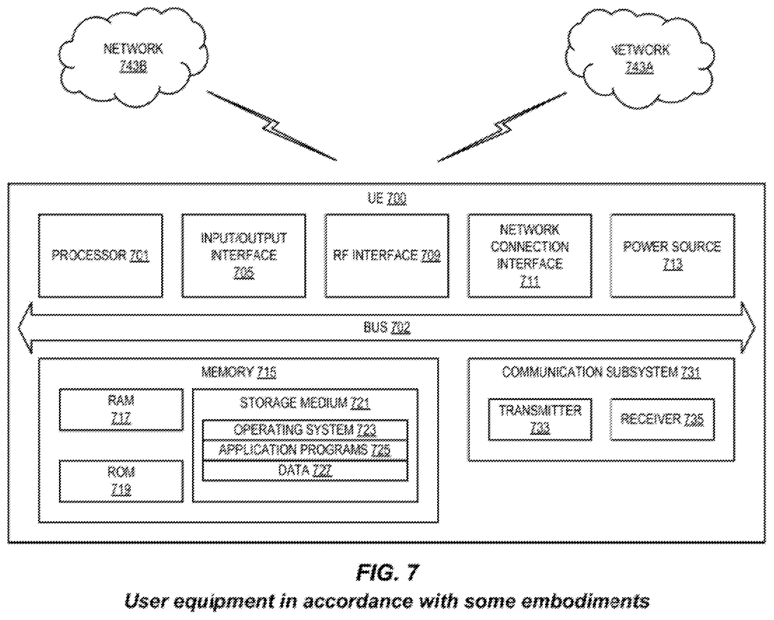

FIG. 7 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 7200 may be any UE identified by the 3GPP, including a NB-IoT UE, a MTC UE, and/or an enhanced MTC (eMTC) UE. UE 700, as illustrated in FIG. 7, is one example of a WD configured for communication in accordance with one or more communication standards promulgated by the 3GPP, such as 3GPP's GSM, UMTS, LTE, and/or 5G standards. As mentioned previously, the term WD and UE may be used interchangeable. Accordingly, although FIG. 7 is a UE, the components discussed herein are equally applicable to a WD, and vice-versa.

In FIG. 7, UE 700 includes processing circuitry 701 that is operatively coupled to input/output interface 705, RF interface 709, network connection interface 711, memory 715 including RAM 717, ROM 719, and storage medium 721 or the like, communication subsystem 731, power source 733, and/or any other component, or any combination thereof. Storage medium 721 includes operating system 723, application program 725, and data 727. In other embodiments, storage medium 721 may include other similar types of information. Certain UEs may utilize all of the components shown in FIG. 7, or only a subset of the components. The level of integration between the components may vary from one UE to another UE. Further, certain UEs may contain multiple instances of a component, such as multiple processors, memories, transceivers, transmitters, receivers, etc.

In FIG. 7, processing circuitry 701 may be configured to process computer instructions and data. Processing circuitry 701 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or DSP, together with appropriate software; or any combination of the above. For example, the processing circuitry 701 may include two CPUs. Data may be information in a form suitable for use by a computer.

In the depicted embodiment, input/output interface 705 may be configured to provide a communication interface to an input device, output device, or input and output device. UE 700 may be configured to use an output device via input/output interface 705. An output device may use the same type of interface port as an input device. For example, a USB port may be used to provide input to and output from UE 700. The output device may be a speaker, a sound card, a video card, a display, a monitor, a printer, an actuator, an emitter, a smartcard, another output device, or any combination thereof. UE 700 may be configured to use an input device via input/output interface 705 to allow a user to capture information into UE 700. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 7, RF interface 709 may be configured to provide a communication interface to RF components such as a transmitter, a receiver, and an antenna. Network connection interface 711 may be configured to provide a communication interface to network 743A. Network 743A may encompass wired and/or wireless networks such as a LAN, a WAN, a computer network, a wireless network, a telecommunications network, another like network or any combination thereof. For example, network 743A may comprise a Wi-Fi network. Network connection interface 711 may be configured to include a receiver and a transmitter interface used to communicate with one or more other devices over a communication network according to one or more communication protocols, such as Ethernet, Transmission Control Protocol (TCP)/IP, Synchronous Optical Networking (SONET), Asynchronous Transfer Mode (ATM), or the like. Network connection interface 711 may implement receiver and transmitter functionality appropriate to the communication network links (e.g., optical, electrical, and the like). The transmitter and receiver functions may share circuit components, software or firmware, or alternatively may be implemented separately.

RAM 717 may be configured to interface via bus 702 to processing circuitry 701 to provide storage or caching of data or computer instructions during the execution of software programs such as the operating system, application programs, and device drivers. ROM 719 may be configured to provide computer instructions or data to processing circuitry 701. For example, ROM 719 may be configured to store invariant low-level system code or data for basic system functions such as basic Input and Output (I/O), startup, or reception of keystrokes from a keyboard that are stored in a non-volatile memory. Storage medium 721 may be configured to include memory such as RAM, ROM, Programmable ROM (PROM), Erasable Programmable ROM (EPROM), Electrically Erasable Programmable ROM (EEPROM), magnetic disks, optical disks, floppy disks, hard disks, removable cartridges, or flash drives. In one example, storage medium 721 may be configured to include operating system 723, application program 725 such as a web browser application, a widget or gadget engine or another application, and data file 727. Storage medium 721 may store, for use by UE 700, any of a variety of various operating systems or combinations of operating systems.

Storage medium 721 may be configured to include a number of physical drive units, such as Redundant Array of Independent Disks (RAID), floppy disk drive, flash memory, USB flash drive, external hard disk drive, thumb drive, pen drive, key drive, High-Density Digital Versatile Disc (HD-DVD) optical disc drive, internal hard disk drive, Blu-Ray optical disc drive, Holographic Digital Data Storage (HDDS) optical disc drive, external mini Dual In-Line Memory Module (DIMM), Synchronous Dynamic RAM (SDRAM), external micro-DIMM SDRAM, smartcard memory such as a Subscriber Identity Module (SIM) or a Removable User Identity (RUIM) module, other memory, or any combination thereof. Storage medium 721 may allow UE 700 to access computer-executable instructions, application programs or the like, stored on transitory or non-transitory memory media, to off-load data, or to upload data. An article of manufacture, such as one utilizing a communication system may be tangibly embodied in storage medium 721, which may comprise a device readable medium.

In FIG. 7, processing circuitry 701 may be configured to communicate with network 743B using communication subsystem 731. Network 743A and network 743B may be the same network or networks or different network or networks. Communication subsystem 731 may be configured to include one or more transceivers used to communicate with network 743B. For example, communication subsystem 731 may be configured to include one or more transceivers used to communicate with one or more remote transceivers of another device capable of wireless communication such as another WD, UE, or base station of a Radio Access Network (RAN) according to one or more communication protocols, such as IEEE 802.7, Code Division Multiple Access (CDMA), Wideband Code Division Multiple Access (WCDMA), GSM, LTE, Universal Terrestrial Radio Access Network (UTRAN), WiMax, or the like. Each transceiver may include transmitter 733 and/or receiver 735 to implement transmitter or receiver functionality, respectively, appropriate to the RAN links (e.g., frequency allocations and the like). Further, transmitter 733 and receiver 735 of each transceiver may share circuit components, software or firmware, or alternatively may be implemented separately.

In the illustrated embodiment, the communication functions of communication subsystem 731 may include data communication, voice communication, multimedia communication, short-range communications such as Bluetooth, near-field communication, location-based communication such as the use of the Global Positioning System (GPS) to determine a location, another like communication function, or any combination thereof. For example, communication subsystem 731 may include cellular communication, Wi-Fi communication, Bluetooth communication, and GPS communication. Network 743b may encompass wired and/or wireless networks such as a LAN, a WAN, a computer network, a wireless network, a telecommunications network, another like network or any combination thereof. For example, network 743B may be a cellular network, a Wi-Fi network, and/or a near-field network. Power source 713 may be configured to provide Alternating Current (AC) or Direct Current (DC) power to components of UE 700.

The features, benefits and/or functions described herein may be implemented in one of the components of UE 700 or partitioned across multiple components of UE 700. Further, the features, benefits, and/or functions described herein may be implemented in any combination of hardware, software or firmware. In one example, communication subsystem 731 may be configured to include any of the components described herein. Further, processing circuitry 701 may be configured to communicate with any of such components over bus 702. In another example, any of such components may be represented by program instructions stored in memory that when executed by processing circuitry 701 perform the corresponding functions described herein. In another example, the functionality of any of such components may be partitioned between processing circuitry 701 and communication subsystem 731. In another example, the non-computationally intensive functions of any of such components may be implemented in software or firmware and the computationally intensive functions may be implemented in hardware.

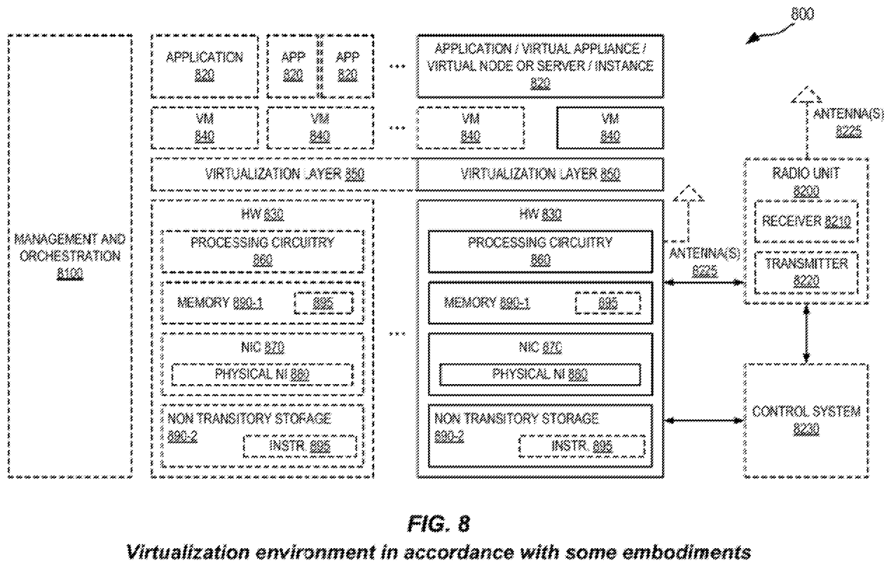

FIG. 8 is a schematic block diagram illustrating a virtualization environment 800 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 800 hosted by one or more of hardware nodes 830. Further, in embodiments in which the virtual node is not a radio access node or does not require radio connectivity (e.g., a core network node), then the network node may be entirely virtualized.

The functions may be implemented by one or more applications 820 (which may alternatively be called software instances, virtual appliances, network functions, virtual nodes, virtual network functions, etc.) operative to implement some of the features, functions, and/or benefits of some of the embodiments disclosed herein. Applications 820 are run in virtualization environment 800 which provides hardware 830 comprising processing circuitry 860 and memory 890. Memory 890 contains instructions 895 executable by processing circuitry 860 whereby application 820 is operative to provide one or more of the features, benefits, and/or functions disclosed herein.

Virtualization environment 800, comprises general-purpose or special-purpose network hardware devices 830 comprising a set of one or more processors or processing circuitry 860, which may be Commercial Off-the-Shelf (COTS) processors, dedicated ASICs, or any other type of processing circuitry including digital or analog hardware components or special purpose processors. Each hardware device may comprise memory 890-1 which may be non-persistent memory for temporarily storing instructions 895 or software executed by processing circuitry 860. Each hardware device may comprise one or more Network Interface Controllers (NICs) 870, also known as network interface cards, which include physical network interface 880. Each hardware device may also include non-transitory, persistent, machine-readable storage media 890-2 having stored therein software 895 and/or instructions executable by processing circuitry 860. Software 895 may include any type of software including software for instantiating one or more virtualization layers 850 (also referred to as hypervisors), software to execute virtual machines 840 as well as software allowing it to execute functions, features and/or benefits described in relation with some embodiments described herein.

Virtual machines 840, comprise virtual processing, virtual memory, virtual networking or interface and virtual storage, and may be run by a corresponding virtualization layer 850 or hypervisor. Different embodiments of the instance of virtual appliance 820 may be implemented on one or more of virtual machines 840, and the implementations may be made in different ways.

During operation, processing circuitry 860 executes software 895 to instantiate the hypervisor or virtualization layer 850, which may sometimes be referred to as a Virtual Machine Monitor (VMM). Virtualization layer 850 may present a virtual operating platform that appears like networking hardware to virtual machine 840.

As shown in FIG. 8, hardware 830 may be a standalone network node with generic or specific components. Hardware 830 may comprise antenna 8225 and may implement some functions via virtualization. Alternatively, hardware 830 may be part of a larger cluster of hardware (e.g., such as in a data center or CPE) where many hardware nodes work together and are managed via Management and Orchestration (MANO) 8100, which, among others, oversees lifecycle management of applications 820.

Virtualization of the hardware is in some contexts referred to as Network Function Virtualization (NFV). NFV may be used to consolidate many network equipment types onto industry standard high volume server hardware, physical switches, and physical storage, which can be located in data centers, and CPE.

In the context of NFV, virtual machine 840 may be a software implementation of a physical machine that runs programs as if they were executing on a physical, non-virtualized machine. Each of virtual machines 840, and that part of hardware 830 that executes that virtual machine, be it hardware dedicated to that virtual machine and/or hardware shared by that virtual machine with others of the virtual machines 840, forms a separate Virtual Network Element (VNE).

Still in the context of NFV, Virtual Network Function (VNF) is responsible for handling specific network functions that run in one or more virtual machines 840 on top of hardware networking infrastructure 830 and corresponds to application 820 in FIG. 8.

In some embodiments, one or more radio units 8200 that each include one or more transmitters 8220 and one or more receivers 8210 may be coupled to one or more antennas 8225. Radio units 8200 may communicate directly with hardware nodes 830 via one or more appropriate network interfaces and may be used in combination with the virtual components to provide a virtual node with radio capabilities, such as a radio access node or a base station.

In some embodiments, some signaling can be effected with the use of control system 8230 which may alternatively be used for communication between the hardware nodes 830 and radio units 8200.

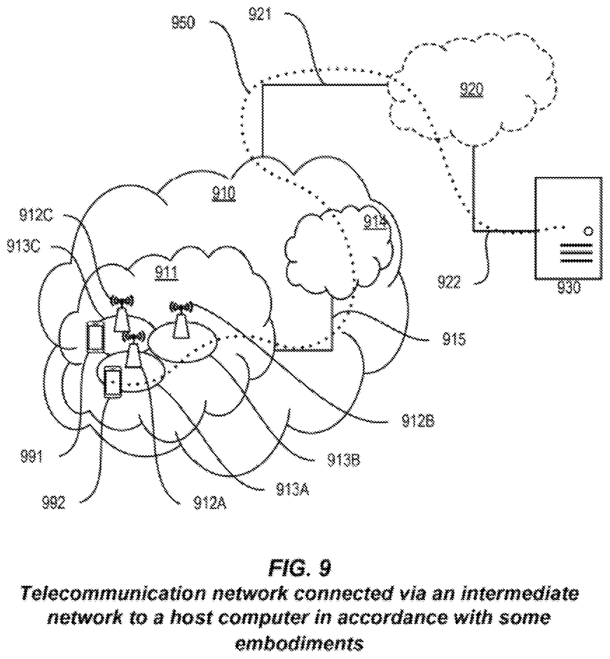

With reference to FIG. 9, in accordance with an embodiment, a communication system includes telecommunication network 910, such as a 3GPP-type cellular network, which comprises access network 911, such as a radio access network, and core network 914. Access network 911 comprises a plurality of base stations 912A, 912B, 912C, such as Node Bs, eNBs, gNBs or other types of wireless access points, each defining a corresponding coverage area 913A, 913B, 913C. Each base station 912A, 912B, 912C is connectable to core network 914 over a wired or wireless connection 915. A first UE 991 located in coverage area 913C is configured to wirelessly connect to, or be paged by, the corresponding base station 912C. A second UE 992 in coverage area 913A is wirelessly connectable to the corresponding base station 912A. While a plurality of UEs 991, 992 are illustrated in this example, the disclosed embodiments are equally applicable to a situation where a sole UE is in the coverage area or where a sole UE is connecting to the corresponding base station 912.

Telecommunication network 910 is itself connected to host computer 930, which may be embodied in the hardware and/or software of a standalone server, a cloud-implemented server, a distributed server or as processing resources in a server farm. Host computer 930 may be under the ownership or control of a service provider, or may be operated by the service provider or on behalf of the service provider. Connections 921 and 922 between telecommunication network 910 and host computer 930 may extend directly from core network 914 to host computer 930 or may go via an optional intermediate network 920. Intermediate network 920 may be one of, or a combination of more than one of, a public, private or hosted network; intermediate network 920, if any, may be a backbone network or the Internet; in particular, intermediate network 920 may comprise two or more sub-networks (not shown).

The communication system of FIG. 9 as a whole enables connectivity between the connected UEs 991, 992 and host computer 930. The connectivity may be described as an Over-the-Top (OTT) connection 950. Host computer 930 and the connected UEs 991, 992 are configured to communicate data and/or signaling via OTT connection 950, using access network 911, core network 914, any intermediate network 920 and possible further infrastructure (not shown) as intermediaries. OTT connection 950 may be transparent in the sense that the participating communication devices through which OTT connection 950 passes are unaware of routing of uplink and downlink communications. For example, base station 912 may not or need not be informed about the past routing of an incoming downlink communication with data originating from host computer 930 to be forwarded (e.g., handed over) to a connected UE 991. Similarly, base station 912 need not be aware of the future routing of an outgoing uplink communication originating from the UE 991 towards the host computer 930.

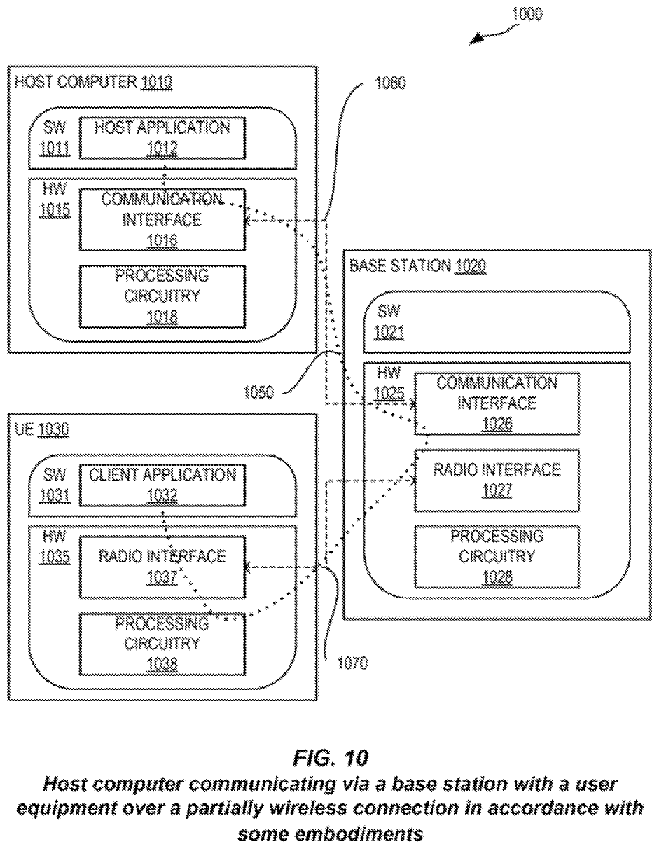

Example implementations, in accordance with an embodiment, of the UE, base station and host computer discussed in the preceding paragraphs will now be described with reference to FIG. 10. In communication system 1000, host computer 1010 comprises hardware 1015 including communication interface 1016 configured to set up and maintain a wired or wireless connection with an interface of a different communication device of communication system 1000. Host computer 1010 further comprises processing circuitry 1018, which may have storage and/or processing capabilities. In particular, processing circuitry 1018 may comprise one or more programmable processors, ASICs, FPGAs, or combinations of these (not shown) adapted to execute instructions. Host computer 1010 further comprises software 1011, which is stored in or accessible by host computer 1010 and executable by processing circuitry 1018. Software 1011 includes host application 1012. Host application 1012 may be operable to provide a service to a remote user, such as UE 1030 connecting via OTT connection 1050 terminating at UE 1030 and host computer 1010. In providing the service to the remote user, host application 1012 may provide user data which is transmitted using OTT connection 1050.

Communication system 1000 further includes base station 1020 provided in a telecommunication system and comprising hardware 1025 enabling it to communicate with host computer 1010 and with UE 1030. Hardware 1025 may include communication interface 1026 for setting up and maintaining a wired or wireless connection with an interface of a different communication device of communication system 1000, as well as radio interface 1027 for setting up and maintaining at least wireless connection 1070 with UE 1030 located in a coverage area (not shown in FIG. 10) served by base station 1020. Communication interface 1026 may be configured to facilitate connection 1060 to host computer 1010. Connection 1060 may be direct or it may pass through a core network (not shown in FIG. 10) of the telecommunication system and/or through one or more intermediate networks outside the telecommunication system. In the embodiment shown, hardware 1025 of base station 1020 further includes processing circuitry 1028, which may comprise one or more programmable processors, ASICs, FPGAs, or combinations of these (not shown) adapted to execute instructions. Base station 1020 further has software 1021 stored internally or accessible via an external connection.

Communication system 1000 further includes UE 1030 already referred to. Its hardware 1035 may include radio interface 1037 configured to set up and maintain wireless connection 1070 with a base station serving a coverage area in which UE 1030 is currently located. Hardware 1035 of UE 1030 further includes processing circuitry 1038, which may comprise one or more programmable processors, ASICs, FPGAs, or combinations of these (not shown) adapted to execute instructions. UE 1030 further comprises software 1031, which is stored in or accessible by UE 1030 and executable by processing circuitry 1038. Software 1031 includes client application 1032. Client application 1032 may be operable to provide a service to a human or non-human user via UE 1030, with the support of host computer 1010. In host computer 1010, an executing host application 1012 may communicate with the executing client application 1032 via OTT connection 1050 terminating at UE 1030 and host computer 1010. In providing the service to the user, client application 1032 may receive request data from host application 1012 and provide user data in response to the request data. OTT connection 1050 may transfer both the request data and the user data. Client application 1032 may interact with the user to generate the user data that it provides.

It is noted that host computer 1010, base station 1020 and UE 1030 illustrated in FIG. 10 may be similar or identical to host computer 930, one of base stations 912A, 912B, 912C and one of UEs 991, 992 of FIG. 9, respectively. This is to say, the inner workings of these entities may be as shown in FIG. 10 and independently, the surrounding network topology may be that of FIG. 9.

In FIG. 10, OTT connection 1050 has been drawn abstractly to illustrate the communication between host computer 1010 and UE 1030 via base station 1020, without explicit reference to any intermediary devices and the precise routing of messages via these devices. Network infrastructure may determine the routing, which it may be configured to hide from UE 1030 or from the service provider operating host computer 1010, or both. While OTT connection 1050 is active, the network infrastructure may further take decisions by which it dynamically changes the routing (e.g., on the basis of load balancing consideration or reconfiguration of the network).

Wireless connection 1070 between UE 1030 and base station 1020 is in accordance with the teachings of the embodiments described throughout this disclosure. One or more of the various embodiments improve the performance of OTT services provided to UE 1030 using OTT connection 1050, in which wireless connection 1070 forms the last segment.

A measurement procedure may be provided for the purpose of monitoring data rate, latency and other factors on which the one or more embodiments improve. There may further be an optional network functionality for reconfiguring OTT connection 1050 between host computer 1010 and UE 1030, in response to variations in the measurement results. The measurement procedure and/or the network functionality for reconfiguring OTT connection 1050 may be implemented in software 1011 and hardware 1015 of host computer 1010 or in software 1031 and hardware 1035 of UE 1030, or both. In embodiments, sensors (not shown) may be deployed in or in association with communication devices through which OTT connection 1050 passes; the sensors may participate in the measurement procedure by supplying values of the monitored quantities exemplified above, or supplying values of other physical quantities from which software 1011, 1031 may compute or estimate the monitored quantities. The reconfiguring of OTT connection 1050 may include message format, retransmission settings, preferred routing etc.; the reconfiguring need not affect base station 1020, and it may be unknown or imperceptible to base station 1020. Such procedures and functionalities may be known and practiced in the art. In certain embodiments, measurements may involve proprietary UE signaling facilitating host computer 1010's measurements of throughput, propagation times, latency and the like. The measurements may be implemented in that software 1011 and 1031 causes messages to be transmitted, in particular empty or ‘dummy’ messages, using OTT connection 1050 while it monitors propagation times, errors etc.

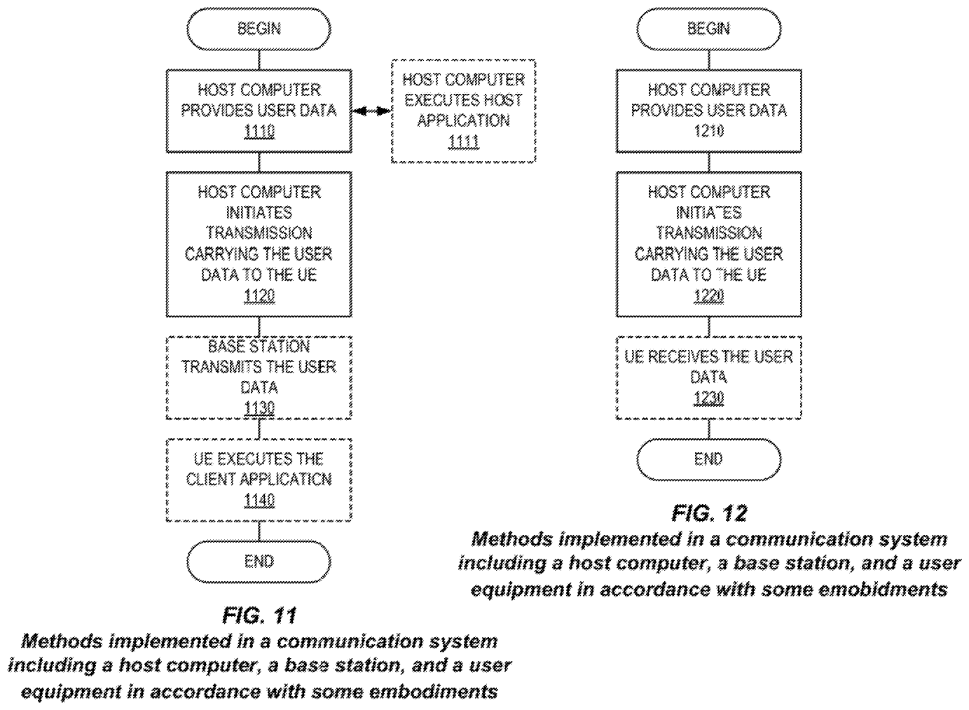

FIG. 11 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 11 will be included in this section. In step 1110, the host computer provides user data. In substep 1111 (which may be optional) of step 1110, the host computer provides the user data by executing a host application. In step 1120, the host computer initiates a transmission carrying the user data to the UE. In step 1130 (which may be optional), the base station transmits to the UE the user data which was carried in the transmission that the host computer initiated, in accordance with the teachings of the embodiments described throughout this disclosure. In step 1140 (which may also be optional), the UE executes a client application associated with the host application executed by the host computer.

FIG. 12 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 12 will be included in this section. In step 1210 of the method, the host computer provides user data. In an optional substep (not shown) the host computer provides the user data by executing a host application. In step 1220, the host computer initiates a transmission carrying the user data to the UE. The transmission may pass via the base station, in accordance with the teachings of the embodiments described throughout this disclosure. In step 1230 (which may be optional), the UE receives the user data carried in the transmission.

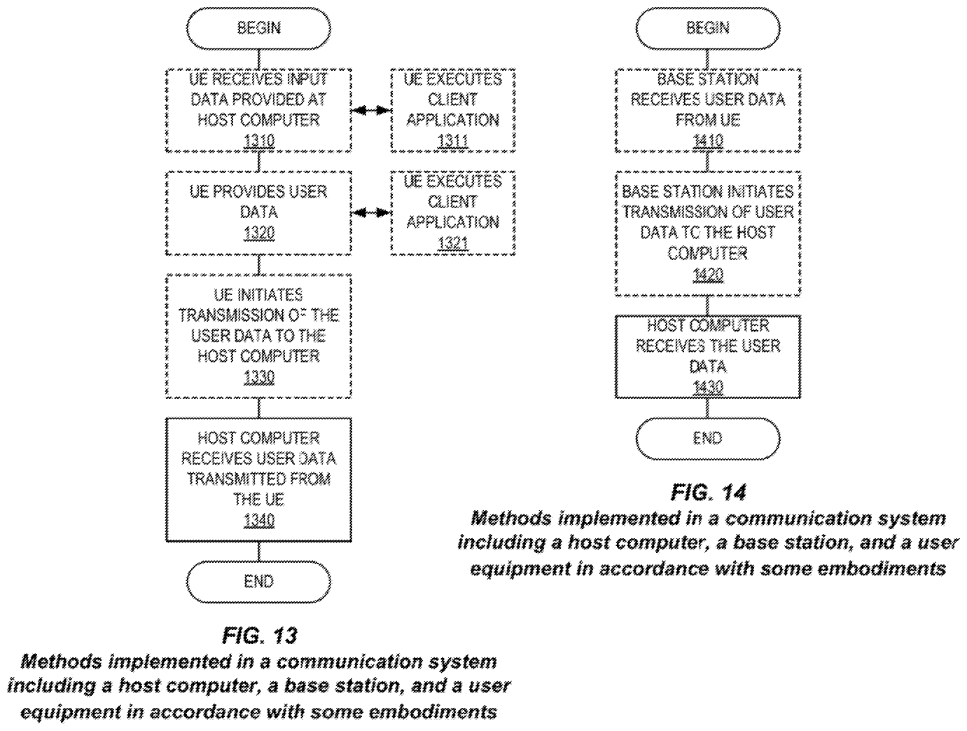

FIG. 13 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 13 will be included in this section. In step 1310 (which may be optional), the UE receives input data provided by the host computer. Additionally or alternatively, in step 1320, the UE provides user data. In substep 1321 (which may be optional) of step 1320, the UE provides the user data by executing a client application. In substep 1311 (which may be optional) of step 1310, the UE executes a client application which provides the user data in reaction to the received input data provided by the host computer. In providing the user data, the executed client application may further consider user input received from the user. Regardless of the specific manner in which the user data was provided, the UE initiates, in substep 1330 (which may be optional), transmission of the user data to the host computer. In step 1340 of the method, the host computer receives the user data transmitted from the UE, in accordance with the teachings of the embodiments described throughout this disclosure.

FIG. 14 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 14 will be included in this section. In step 1410 (which may be optional), in accordance with the teachings of the embodiments described throughout this disclosure, the base station receives user data from the UE. In step 1420 (which may be optional), the base station initiates transmission of the received user data to the host computer. In step 1430 (which may be optional), the host computer receives the user data carried in the transmission initiated by the base station.

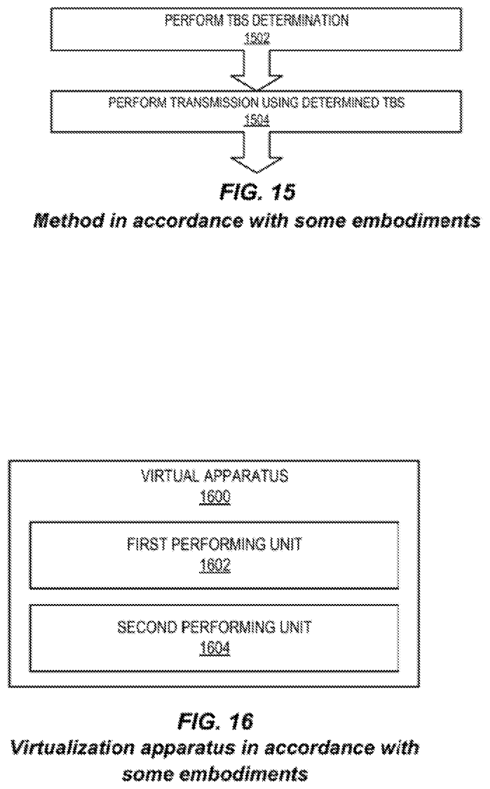

FIG. 15 depicts a method in accordance with particular embodiments, the method comprises performing TBS determination as disclosed herein (e.g., in accordance with any of the embodiments described above) (step 1502) and performing transmission using the determined TBS (step 1504). Optionally, step 1504 comprises refraining from transmitting filler bits as described above. The method of FIG. 15 may be performed by, e.g., a network node such as, e.g., one of the network nodes 660 or by a wireless device such as, e.g., one of the wireless devices 610.

FIG. 16 illustrates a schematic block diagram of an apparatus 1600 in a wireless network (for example, the wireless network shown in FIG. 6). The apparatus may be implemented in a wireless device or network node (e.g., wireless device 610 or network node 660 shown in FIG. 6). Apparatus 1600 is operable to carry out the example method described with reference to FIG. 15 and possibly any other processes or methods disclosed herein. It is also to be understood that the method of FIG. 15 is not necessarily carried out solely by apparatus 1600. At least some operations of the method can be performed by one or more other entities.

Virtual Apparatus 1600 may comprise processing circuitry, which may include one or more microprocessor or microcontrollers, as well as other digital hardware, which may include DSPs, special-purpose digital logic, and the like. The processing circuitry may be configured to execute program code stored in memory, which may include one or several types of memory such as ROM, RAM, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause first performing unit 1602, second performing unit 1604, and any other suitable units of the apparatus 1600 to perform corresponding functions according one or more embodiments of the present disclosure.

As illustrated in FIG. 16, apparatus 1600 includes first performing unit 1602 and second performing unit 1604. The first performing unit 1602 is configured to perform TBS determination in accordance with any embodiment(s) described herein. The second performing unit 1604 is configured to perform transmission using the determined TBS.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### Exemplary Embodiments

Some exemplary embodiments are as follows.

Embodiment 1: A method performed by a transmitter or receiver including:

determining an intermediate number of information bits, Ninfo, to be transmitted from a number of allocated physical resource blocks, PRB, a number of resource elements, RE, per PRB, a number of multiple input multiple output, MIMO layers, a modulation order and a target code rate for transmission of the information bits;

quantizing the intermediate number of information bits as a first integer multiple of a second integer, where the second integer is equal to 2-to-the-power of a third integer, to provide a quantized intermediate number of information bits;

determining a transport block size from the quantized intermediate number of information bits; and

transmitting or receiving a transport block over a physical channel according to the determined transport block size;

wherein the third integer is calculated as a binary logarithm of the intermediate number of information bits, Ninfo, and

wherein the third integer is set to zero if the binary logarithm of the intermediate number of information bits, Ninfo, is less than a fourth integer.

Embodiment 2: The method of embodiment 1, wherein the fourth integer is equal to five.

Embodiment 3: The method of embodiment 1, where the third integer is further obtained by calculating a binary logarithm of a linear function of Ninfo.

Embodiment 4: The method of embodiment 3, where the third integer is further obtained by calculating a floor of the binary logarithm of the linear function of Ninfo.

Embodiment 5: The method of embodiment 4, where the third integer is further adjusted by reducing the floor of the binary logarithm by the fourth integer.

Embodiment 6: The method of embodiment 1, where the first integer is obtained using the intermediate number of information bits, Ninfo.

Embodiment 7: The method of embodiment 6, where the first integer is further obtained by using a round function.

Embodiment 8: The method of embodiment 6, where the first integer is further obtained by using a round function of a variable that is derived by dividing a linear function of Ninfo by the second integer.

Embodiment 9: The method of any previous embodiment, where the physical channel is a physical downlink shared channel.

Embodiment 10: The method of any previous embodiment, where the physical channel is a physical uplink shared channel.

Embodiment 11: A radio node in a cellular communications network, the radio node adapted to perform the method of any one of embodiments 1-10.

Embodiment 12: The radio node of embodiment 11 wherein the radio node is a base station.

Embodiment 13: The radio node of embodiment 11 wherein the radio node is a User Equipment, UE.

Embodiment 14: A radio node in a cellular communications network, comprising:

an interface operable to wirelessly transmit signals to and/or wirelessly receive signals from another node in the cellular communications network; and

processing circuitry associated with the interface, the processing circuitry operable to perform the method of any one of embodiments 1-10.

Embodiment 15: The radio node of embodiment 14 wherein the radio node is a base station.

Embodiment 16: The radio node of embodiment 14 wherein the radio node is a User Equipment, UE.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).
2G Second Generation
3G Third Generation
3GPP Third Generation Partnership Project
4G Fourth Generation
5G Fifth Generation
AC Alternating Current
AP Access Point
ASIC Application Specific Integrated Circuit
ATM Asynchronous Transfer Mode
BS Base Station
BSC Base Station Controller
BTS Base Transceiver Station
CD Compact Disk
CDMA Code Division Multiple Access
COTS Commercial Off-the-Shelf
CPE Customer Premise Equipment
CPU Central Processing Unit
CRC Cyclic Redundancy Check
D2D Device-to-Device
DAS Distributed Antenna System
DC Direct Current
DCI Downlink Control Information
DIMM Dual In-Line Memory Module
DL Downlink
DSP Digital Signal Processor
DVD Digital Video Disk
DwPTS Downlink Pilot Time Slot
EEPROM Electrically Erasable Programmable Read Only Memory
eMTC Enhanced Machine Type Communication
eNB Enhanced or Evolved Node B
EPROM Erasable Programmable Read Only Memory
E-SMLC Evolved Serving Mobile Location Center
FDD Frequency Division Duplexing
FPGA Field Programmable Gate Array
GHz Gigahertz
gNB New Radio Base Station
GPS Global Positioning System
GSM Global System for Mobile Communications
HARQ Hybrid Automatic Repeat Request
HDDS Holographic Digital Data Storage
HD-DVD High-Density Digital Versatile Disc
ID Identity
I/O Input and Output
IoT Internet of Things
IP Internet Protocol
kHz Kilohertz
LAN Local Area Network
LBT Listen-Before-Talk
LDPC Low-Density Parity-Check
LEE Laptop Embedded Equipment
LME Laptop Mounted Equipment
LPDC Low-Parity Density-Check
LTE Long Term Evolution
M2M Machine-to-Machine
MANO Management and Orchestration
MCE Multi-Cell/Multicast Coordination Entity
MCS Modulation and Coding Scheme
MDT Minimization of Drive Tests
MIMO Multiple Input Multiple Output
MME Mobility Management Entity
MSC Mobile Switching Center
MSR Multi-Standard Radio
MTC Machine Type Communication
NB-IoT Narrowband Internet of Things
NFV Network Function Virtualization
NIC Network Interface Controller
NR New Radio
O&M Operation and Maintenance
OFDM Orthogonal Frequency Division Multiplexing
OSS Operations Support System
OTT Over-the-Top
PDA Personal Digital Assistant
PDCCH Physical Downlink Control Channel
PDSCH Physical Downlink Shared Channel
PRB Physical Resource Block
PROM Programmable Read Only Memory
PSTN Public Switched Telephone Networks
PUCCH Physical Uplink Control Channel
QAM Quadrature Amplitude Modulation
QPSK Quadrature Phase Shift Keying
RAID Redundant Array of Independent Disks
RAM Random Access Memory
RAN Radio Access Network
RAT Radio Access Technology
RE Resource Element
RF Radio Frequency
RNC Radio Network Controller
ROM Read Only Memory
RRH Remote Radio Head
RRU Remote Radio Unit
RUIM Removable User Identity
SDRAM Synchronous Dynamic Random Access Memory
SIM Subscriber Identity Module
SOC System on a Chip
SON Self-Organizing Network
SONET Synchronous Optical Networking
TBS Transport Block Size
TCP Transmission Control Protocol
TDD Time Division Duplexing
TPC Transmit Power Control
TRP Transmission-Receive-Point
TS Technical Specification
UE User Equipment
UL Uplink
UMTS Universal Mobile Telecommunications System
USB Universal Serial Bus
UTRAN Universal Terrestrial Radio Access Network
V2I Vehicle-to-Infrastructure
V2V Vehicle-to-Vehicle
V2X Vehicle-to-Everything
VMM Virtual Machine Monitor
VNE Virtual Network Element
VNF Virtual Network Function
VoIP Voice over Internet Protocol
VRB Virtual Resource Block
WAN Wide Area Network
WCDMA Wideband Code Division Multiple Access
WD Wireless Device
WiMax Worldwide Interoperability for Microwave Access
WLAN Wireless Local Area Network

Those skilled in the art will recognize improvements and modifications to the embodiments of the present disclosure. All such improvements and modifications are considered within the scope of the concepts disclosed herein.

1. A method performed by a transmitter or receiver, comprising:
determining an intermediate number of information bits, Ninfo, to be transmitted from a number of allocated physical resource blocks, (PRB) a number of resource elements (REs) per PRB, a number of multiple input multiple output (MIMO) layers, a modulation order and a target code rate for transmission of the information bits;
quantizing the intermediate number of information bits as a first integer multiple of a second integer, wherein the second integer is equal to 2-to-the-power of a third integer, to provide a quantized intermediate number of information bits;
determining a transport block size from the quantized intermediate number of information bits; and
transmitting or receiving a transport block over a physical channel according to the determined transport block size; and
wherein the third integer is calculated based on a binary logarithm of Ninfo.

2. The method of claim 1, wherein the third integer is set to zero if the binary logarithm of Ninfo is less than a fourth integer.

3. The method of claim 2, wherein the fourth integer is equal to five.

4. The method of claim 1, wherein the third integer is further obtained based on calculating a binary logarithm of a linear function of Ninfo.

5. The method of claim 4, wherein the third integer is further obtained based on calculating a floor of the binary logarithm of the linear function of Ninfo.

6. The method of claim 5, wherein the third integer is further adjusted based on reducing the floor of the binary logarithm by a fourth integer.

7. The method of claim 1, wherein the first integer is obtained based on Ninfo.

8. The method of claim 7, wherein the first integer is further obtained based on a round function.

9. The method of claim 7, wherein the first integer is further obtained based on a round function of a variable that is derived by dividing a linear function of Ninfo by the second integer.

10. The method of claim 1, wherein the physical channel is a physical downlink shared channel.

11. The method of claim 1, wherein the physical channel is a physical uplink shared channel.

12-14. (canceled)

15. A radio node operable in a cellular communications network, the radio node comprising:
an interface operable to wirelessly transmit signals to and/or wirelessly receive signals from another node in the cellular communications network; and
processing circuitry associated with the interface, the processing circuitry operable to perform operations comprising:
determining an intermediate number of information bits (Ninfo) to be transmitted from a number of allocated physical resource blocks (PRB) a number of resource elements (REs) per PRB, a number of multiple input multiple output (MIMO) layers, a modulation order and a target code rate for transmission of the information bits;
quantizing the intermediate number of information bits as a first integer multiple of a second integer, wherein the second integer is equal to 2-to-the-power of a third integer, to provide a quantized intermediate number of information bits;
determining a transport block size from the quantized intermediate number of information bits; and
transmitting or receiving a transport block over a physical channel according to the determined transport block size; and
wherein the third integer is calculated based on a binary logarithm of Ninfo.

16. The radio node of claim 15 wherein the radio node is a base station.

17. (canceled)

18. A user equipment, (UE) for communication with a cellular communications network, the UE comprising:
an interface operable to wirelessly transmit signals to another node in the cellular communications network; and
processing circuitry associated with the interface, the processing circuitry operable to perform operations comprising:
determining an intermediate number of information bits (Ninfo) to be transmitted from a number of allocated physical resource blocks (PRB) a number of resource elements (REs) per PRB, a number of multiple input multiple output (MIMO) layers, a modulation order and a target code rate for transmission of the information bits;
quantizing the intermediate number of information bits as a first integer multiple of a second integer, wherein the second integer is equal to 2-to-the-power of a third integer, to provide a quantized intermediate number of information bits;
determining a transport block size from the quantized intermediate number of information bits; and
transmitting or receiving a transport block over a physical channel according to the determined transport block size; and
wherein the third integer is calculated based on a binary logarithm of Ninfo.

19. The UE of claim 18, wherein the third integer is set of zero if the binary logarithm of Ninfo is less than a fourth integer.

20. The UE of claim 19, wherein the fourth integer is equal to five.

21. The UE of claim 18, wherein the third integer is further obtained by calculating a binary logarithm of a linear function of Ninfo.

22. The UE of claim 21, wherein the third integer is further obtained by calculating a floor of the binary logarithm of the linear function of Ninfo.

23. The UE of claim 22, wherein the third integer is further adjusted by reducing the floor of the binary logarithm by a fourth integer.

24. The UE of claim 18, wherein the first integer is obtained using the intermediate number of information bits, Ninfo.

25. The UE of claim 24, wherein the first integer is further obtained by using a round function.

26. The UE of claim 24, wherein the first integer is further obtained by using a round function of a variable that is derived by dividing a linear function of Ninfo by the second integer.

27. The UE of claim 18, wherein the physical channel is a physical downlink shared channel.

28. The UE of claim 18, wherein the physical channel is a physical uplink shared channel.
